(19) United States
(12) Patent Application Publication
(10) Pub. No.: US 2026/0357005 A1
(43) Pub. Date: Nov. 12, 2026

(54) COMPOSITIONS CONTAINING THERMALLY CONDUCTIVE FILLER AND THERMALLY EXPANDABLE MATERIAL

(71) Applicant: PPG Industries Ohio, Inc., Cleveland, OH (US)

(72) Inventors: Paul Takunda Chazovachii, Allison Park, PA (US); Hongying Zhou, Allison Park, PA (US); Marvin Michael Pollum, JR., Pittsburgh, PA (US); Joseph Peter Kriley, Valencia, PA (US); Masayuki Nakajima, Wexford, PA (US); Daniel Philip Jahanian, Pittsburgh, PA (US); Calum Hugh Munro, Gibsonia, PA (US); Courtney Lyn Balliet, Pittsburgh, PA (US)

(73) Assignee: PPG Industries Ohio, Inc., Cleveland, OH (US)

(21) Appl. No.: 19/487,517

(22) PCT Filed: Apr. 1, 2024
(86) PCT No.: PCT/US2024/022540

§ 371 Date: Nov. 25, 2025

Related U.S. Application Data
(60) Provisional application No. 63/505,645, filed on Jun. 1, 2023.
(60) Provisional application No. 63/557,950, filed on Feb. 26, 2024.

(51) Int. Cl. C08G 59/66; C08G 59/18; C08J 9/00; C08J 9/32; C09D 163/00

(52) U.S. Cl. CPC C08G 59/66; C08G 59/184; C08J 9/0066; C08J 9/32; C09D 163/00; C08J 2201/022; C08J 2203/22; C08J 2363/00

(57) ABSTRACT

Disclosed are compositions comprising a first component comprising a first molecule comprising an epoxy functional group and a second component comprising a second molecule comprising a thiol functional group. The composition also comprises a thermally expandable material and a thermally conductive filler. The epoxy functional group and the thiol functional group are reactive under ambient conditions. Also disclosed are coatings formed from the compositions.

### CROSS-REFERENCE TO RELATED APPLICATIONS

This application claims priority to U.S. Provisional Application No. 63/505,645, filed Jun. 1, 2023, and to U.S. Provisional Application No. 63/557,950, filed Feb. 26, 2024, both entitled “Compositions Containing Thermally Conductive Filler and Thermally Expandable Material,” and both incorporated by reference herein in their entireties.

### GOVERNMENT CONTRACT

This disclosure was made with Government support under Government Contract No. NCMS FY2019NMP-FREE LI BATTERIES PHASE III 202050 awarded by the GVSC. The United States Government may have certain rights in the subject matter disclosed herein.

### FIELD

Thermally insulative compositions and uses thereof are disclosed.

### BACKGROUND

Thermal insulation allows for protection of the surrounding battery cells and housing at thermal runaway conditions. The present disclosure is directed toward compositions that are thermally conductive under normal operating conditions but thermally insulative under extreme conditions.

### SUMMARY

Disclosed are composition comprising: a first component comprising a first molecule comprising an epoxy functional group; a second component comprising a second molecule comprising a thiol functional group; a thermally expandable material; and a thermally conductive filler; wherein the epoxy functional group and the thiol functional group are reactive under ambient conditions.

Also disclosed are methods of coating a substrate comprising: contacting a portion of a surface of the substrate with a composition disclosed herein.

Also disclosed are methods of forming an article comprising extruding a composition disclosed herein.

Also disclosed are substrates comprising a coating formed from a composition disclosed herein on a portion of a surface of the substrate.

Also disclosed are articles comprising the coated substrates.

Also disclosed are batteries comprising a battery cell and a coating formed from a composition disclosed herein.

### BRIEF DESCRIPTION OF THE DRAWINGS

FIG. 1 is a schematic of a top-down view of cylindrical battery cells.

FIG. 2 is a schematic of an exploded isometric view of an array of prismatic battery cells.

FIG. 3 is a schematic of a front view of an array of pouch battery cells.

FIG. 4 is a schematic of an isometric view of cylindrical cells positioned in a battery module.

FIG. 5 is a schematic of an exploded perspective view of a battery pack comprising multiple battery cells.

FIG. 6 is a schematic of an isometric view of (A) a battery cell, (B) a battery module, and (C) a battery pack.

FIG. 7 is a schematic of a perspective view of a battery pack.

FIG. 8 is a schematic of a cell to battery pack configuration.

FIG. 9 is a schematic of an isometric cut-out view of a cell to chassis battery assembly.

### DETAILED DESCRIPTION

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. As used herein, open-ended terms include closed terms such as consisting essentially of and consisting of.

In this application, the use of the singular includes the plural and plural encompasses singular, unless specifically stated otherwise. For example, although reference is made herein to “a” thermally conductive filler, and “a” thermally expandable material, a combination (i.e., a plurality) of these components may be used.

In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on,” “deposited onto,” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

As used herein, a “coating composition” refers to a composition, e.g., a solution, mixture, or a dispersion, that, is capable of producing a coating on a portion of a substrate surface. “Coating” as used herein includes films, layers and the like.

As used herein, a “sealant composition” refers to a coating composition that forms a sealant in its cured state.

As used herein, a “sealant” refers to a coating that has a tensile strength of at least 0.05 MPa measured according to ISO-37 TYPE 2 using an Instron 4443 machine in tensile mode with a pull rate of 10 mm per minute.

As used herein, a “gap filler composition” refers to a coating composition that forms a gap filler in its cured state.

As used herein, a “gap filler” refers to a coating that fills a gap and that has a butt joint strength of at least 0.001 N/mm² measured according to ASTM D2095.

As used herein, an “adhesive composition” refers to a coating composition that forms an adhesive in its cured state.

As used herein, an “adhesive” refers to a coating that produces a load-bearing joint, such as a load-bearing joint having a lap shear strength of at least 0.05 MPa, as determined according to ASTM D1002-10 using an Instron 5567 machine in tensile mode with a pull rate of 1 mm per minute.

As further defined herein, ambient conditions generally refer to room temperature (e.g. 23 °C) and humidity conditions or temperature and humidity conditions that are typically found in the area in which the composition is applied to a substrate, e.g., at 10 °C to 40 °C and 5% to 80% relative humidity, while slightly thermal conditions are temperatures that are slightly above ambient temperature but are generally below the expansion onset temperature of the composition (i.e., in other words, at temperatures and humidity conditions below which the reactive components will readily react and cure, e.g., >40 °C and less than 220 °C at 20% to 80% relative humidity).

As used herein, a “1K” or “one-component” coating composition, is a composition in which all the ingredients may be premixed and stored and wherein the reactive components do not readily react at ambient or slightly thermal conditions, but instead only react upon activation by an external energy source. In the absence of activation from the external energy source, the composition will remain largely uncured. External energy sources that may be used to promote the curing reaction (i.e., the crosslinking or interaction) include, for example, radiation (i.e., actinic radiation) and/or hcat.

As used herein, the term “two-component” or “2K” refers to a composition in which at least a portion of the reactive components readily associate to form an interaction or react to form a bond (physically or chemically), i.e., cure, without activation from an external energy source, such as at ambient or slightly thermal conditions, when mixed. One of skill in the art understands that the two components of the composition are stored separately from each other and mixed just prior to application of the composition. Two-component compositions may optionally be heated or baked, as described below.

As used herein, the term “cure,” “curing,” and similar terms, means that the components that form the composition form a coating or a bond by being subjected to conditions that lead to the chemical reaction (such as through polymerization) or physical interaction (such as through entanglement) of the components of the composition, resulting in harder, tougher, and/or more stable linkage(s) compared to such properties prior to being subjected to such conditions. In the case of a 1K composition, the composition begins to cure when the composition is exposed to external energy sources. In the case of a 2K composition, the composition begins to cure when the components of the composition are mixed, resulting in the reaction of the reactive functional groups of the components of the composition and/or the physical interaction of the components of the composition.

As used herein, the “epoxy equivalent weight” is determined by dividing the measured Mw of an epoxy-containing compound by the average number of epoxide functional groups present in the epoxy-containing compound.

As used herein, the “thiol equivalent weight” is determined by dividing the measured Mw of a thiol-containing compound by the average number of thiol functional groups present in the thiol-containing compound.

As used herein, the term “monofunctional” refers to a molecule containing only one functional group wherein the functional group only reacts to form one new bond.

As used herein, the term “difunctional” refers to a molecule containing two functional groups wherein the functional groups react to form two new bonds with different molecules more than one time through the same atom (e.g., a primary amine, an alkyne, etc.) and/or through multiple single reactions of atoms within the molecule.

As used herein, the term “polyfunctional” refers to a molecule containing more than two functional groups wherein the functional groups react to form more than two new bonds with different molecules more than one time through the same atom (e.g., a primary amine, an alkyne, etc.) and/or through multiple single reactions of atoms within the molecule.

As used herein, “Mw” refers to the weight average molecular weight, for example the theoretical value as determined by Gel Permeation Chromatography using Waters 2695 separation module with a Waters 410 differential refractometer (RI detector) and polystyrene standards, tetrahydrofuran (THF) used as the eluent at a flow rate of 1 ml min⁻¹, and two PL Gel Mixed C columns used for separation.

As used herein, “polymer” refers to oligomers, homopolymers, and copolymers.

As used herein, “small molecule” refers to a molecule that comprises discrete chemical structures, has a molecular weight of less than 400 g/mol and that is not a polymer (i.e., is not composed of repeating units). The molecular weight of a small molecule may be determined by mass spectrometry. Appropriate mass spectrometry methods for various types of small molecules are available in many references, such as Mass Spectrometry: A Textbook (3^{rd} Edition, 2018, edited by Jürgen Gross).

As used herein, the term “thermally conductive filler” or “TC” filler means a pigment, filler, or inorganic powder that has a thermal conductivity of at least 5 W/m·K at 25 °C measured according to ASTM D7984.

As used herein, the term “non-thermally conductive filler” or “NTC filler” means a pigment, filler, or inorganic powder that has a thermal conductivity of less than 5 W/m·K at 25 °C measured according to ASTM D7984.

As used herein, the term “electrically insulative filler” or “EI filler” means a pigment, filler, or inorganic powder that has a volume resistivity of at least 1 ω·m measured according to ASTM D257.

As used herein, the term “electrically conductive filler” or “EC filler” means a pigment, filler, or inorganic powder that has a volume resistivity of less than 1 Ω·m measured according to ASTM D257.

As used herein, the term “thermally stable” means a pigment, filler, or inorganic powder that, when tested using the TGA test under air according to ASTM E1131, has no more than 5% weight loss of the total weight of the pigment, filler, or powder occurring before 600 °C.

As used herein, the term “thermally unstable” means a pigment, filler, or inorganic powder that, when tested using the TGA test under air according to ASTM E1131, has a weight loss of the total weight of the pigment of more than 5% occurring before 600 °C.

As used herein, the term “thermally expandable material” means a pigment, filler, encapsulant, thermoplastic, inorganic powder, capsule, microcapsule, or the like that has an expansion volume ratio of at least 1.5 upon exposure to a temperature equal to or higher than its expansion onset temperature.

As used herein the term “D50” means the point in the size distribution in which 50 percent or more of the total volume of material in the sample is contained. For example, a D50 of 5 μm means that 50 percent of the particles of the sample have a size of 5 μm or smaller as measured by methods known to those skilled in the art, such as laser diffraction or Low Angle Laser Light Scattering (LALLS).

As used herein, the term “expansion volume ratio,” when used with respect to the thermally expandable material, =(final volume)/(initial volume), wherein the final volume is measured at 25 °C following exposure to at least the expansion onset temperature of the thermally expandable material, wherein the initial volume is measured at 25 °C prior to exposure to at least the expansion onset temperature of the thermally expandable material, and wherein the initial and final volumes are measured using methods known to those skilled in the art, such as SEM, laser diffraction, or LALLS.

As used herein, the term “expansion volume ratio,” when used with respect to a coating, =(final volume)/(initial volume), wherein the final volume is measured after the coating is cooled to a coating temperature of 25 °C following exposure to at least the expansion onset temperature of the thermally expandable material, wherein the initial volume is measured at a coating temperature of 25 °C prior to exposure to at least the expansion onset temperature of the thermally expandable material, wherein the coating is cohesive, and wherein the initial and final volumes are measured using a caliper.

As used herein, the term “cohesive,” when used with respect to a coating, means the expanded coating (a coating that has been exposed to at least the expansion onset temperature of the thermally expandable material) is held together as part of a single mass, i.e., the expanded coating does not crumble.

As used herein, the term “non-cohesive,” when used with respect to a coating, means the expanded coating (a coating that has been exposed to at least the expansion onset temperature of the thermally expandable material) is not held together as part of the same mass, i.e., the expanded coating crumbles.

As used herein, the term “expansion onset temperature” means the temperature at which a thermally expandable material begins to undergo an increase in volume, i.e., the temperature at which the thermally expandable material begins to expand.

As used herein, the term “pre-expansion” means prior to exposure to at least the expansion onset temperature of the thermally expandable material.

As used herein, the term “post-expansion” means after exposure to at least the expansion onset temperature of the thermally expandable material.

As used herein, the term “solvent” refers to a molecule or a compound that is used to lower the viscosity of a resin, volatilizes under ambient conditions, and does not have a reactive functional group capable of reacting with molecules or compounds in a composition.

As used herein, the term “reactive diluent” refers to a molecule or a compound that is used to lower the viscosity of a resin but that has at least one functional group capable of reacting with molecules or compounds in a composition.

As used herein, the term “plasticizer” refers to a molecule or a compound that does not have a functional group capable of reacting with molecules or compounds in a composition, does not volatilize under ambient conditions, and that is added to the composition to decrease viscosity, decrease glass transition temperature (Tg), and impart flexibility and that does not volatilize under ambient conditions.

As used herein, the term “system” refers to a plurality of compositions for application to a substrate surface that results in a plurality of layers formed on the substrate surface. The system may be part of a production line (such as a factory production line) that produces a finished substrate or that produces a treated substrate suitable for use in additional production lines. Unless indicated to the contrary, reference to a “first composition,” a “second composition,” etc., when used with respect to a “system” is not intended to imply a specific order of treatment but rather is for ease of reference only.

As used herein, unless indicated otherwise, the term “substantially free” means that a particular material is not purposefully added to a mixture or composition, respectively, and is only present as an impurity in a trace amount of less than 0.05% by weight based on a total weight of the mixture or composition, respectively. As used herein, unless indicated otherwise, the term “essentially free” means that a particular material is only present in an amount of less than 0.01% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material.

Disclosed herein is a composition comprising, or consisting essentially of, or consisting of: a first component comprising, or consisting essentially of, or consisting of, a first molecule comprising an epoxide functional group; a second component comprising, or consisting essentially of, or consisting of, a second molecule comprising a thiol functional group; a thermally expandable material; and a thermally conductive filler; wherein the epoxide functional group and the thiol functional group are reactive under ambient conditions.

### Molecules Comprising Epoxide Functional Groups

The first component may comprise, or consist essentially of, or consist of, a molecule comprising an epoxide functional group. The epoxy-containing molecule may be monofunctional, difunctional, or polyfunctional. The molecule may be a small molecule, a monomer, an oligomer or a polymer. That is, the molecule may comprise an epoxy-containing compound.

Suitable epoxy-containing molecules that may be used in the compositions disclosed herein may comprise monoepoxides, diepoxides, and/or polyepoxides.

Suitable monoepoxides that may be used include monoglycidyl ethers of alcohols and phenols, such as phenyl glycidyl ether, n-butyl glycidyl ether, cresyl glycidyl ether, isopropyl glycidyl ether, glycidyl versatate, for example, CARDURA E available from Shell Chemical Co., and glycidyl esters of monocarboxylic acids such as glycidyl neodecanoate, Epodil 741 available from Evonik, Epodil 746 available from Evonik, ERISYS® GE-7 available from CVC Thermoset Specialties, mono-functional aliphatic diluents such as Epotec RD 108, RD 109, RD 188 available from Aditya Birla, mono-functional aromatic reactive diluents such as Epotec RD 104, RD 105, and RD 136 available from Aditya Birla, and mixtures of any of the foregoing.

Suitable diepoxides include diglycidyl ethers of Bisphenol A, such as Epon® 828 and 1001 epoxy resins, and Bisphenol F diepoxides, such as Epon® 862, which are commercially available from Hexion Specialty Chemicals, Inc. Other suitable diepoxides included diglycidyl ethers of dihydric alcohols, diglycidyl esters of dicarboxylic acids, diepoxides that are derived from the epoxidation of an olefinically unsaturated alicyclic compound, diepoxides that are derived from the epoxidation of an olefinically unsaturated nonaromatic cyclic compound, diepoxides containing oxyalkylene groups in the epoxy molecule, epoxy novolac resins, 1,4-butandiol diglycidyl ether (available as Heloxy modifier BD from Hexion), 1,6-hexanediol diglycidyl ether, and mixtures of any of the foregoing.

Suitable polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides that are derived from the epoxidation of an olefinically unsaturated nonaromatic cyclic compound, polyepoxides containing oxyalkylene groups in the epoxy molecule, and epoxy novolac resins. Still other suitable epoxy-containing compounds include epoxidized Bisphenol A novolacs, epoxidized phenolic novolacs, epoxidized cresylic novolac, and triglycidyl p-aminophenol bismaleimide. The epoxy-containing molecule may also comprise an epoxy-dimer acid adduct. The epoxy-dimer acid adduct may be formed as the reaction product of reactants comprising a diepoxide compound (such as a polyglycidyl ether of Bisphenol A) and a dimer acid (such as a C36 dimer acid). Other suitable polyepoxides include homopolymers of 1,2-butadiene or 1,4-butadiene or combinations thereof, copolymers of butadiene and acrylic or olefin monomers, or combinations thereof. The epoxy-containing molecule may also comprise a carboxyl-terminated butadiene-acrylonitrile copolymer. Other suitable examples of polyepoxides include saturated epoxidized oils, epoxidized unsaturated oils such as glycerides of polyunsaturated fatty acids such as nut oils or seed oils, including as examples cashew nut oil, sunflower oil, safflower oil, soybean oil, linseed oil, castor oil, orange oil, rapeseed oil, tall oil, vegetable processing oil, tung oil, vulcanized vegetable oil, high oleic acid sunflower oil, and combinations thereof. The epoxy-containing molecule may also comprise epoxidized castor oil. The epoxy-containing molecule may also comprise an epoxy-containing acrylic, such as glycidyl methacrylate. The epoxy-containing molecule may also comprise an epoxy-containing polymer such as epoxy-containing polyacrylate.

The epoxy-containing molecule may comprise an epoxy-adduct. The composition may comprise one or more epoxy-adducts. As used herein, the term “epoxy-adduct” refers to a reaction product of one molecule that is at least difunctional and comprises at least one epoxide functional group and at least one other molecule that does not include an epoxide functional group. For example, the epoxy-adduct may comprise the reaction product of reactants comprising: (1) an epoxy-containing compound, a polyol, and an anhydride; (2) an epoxy-containing compound, a polyol, and a diacid; or (3) an epoxy-containing compound, a polyol, an anhydride, and a diacid.

The epoxy-containing molecule used to form the epoxy-adduct may comprise any of the epoxy-containing molecules listed above that may be included in the composition.

The polyol used to form the epoxy-adduct may include diols, triols, tetraols and higher functional polyols, i.e., compounds comprising five or more hydroxyl groups per molecule. Combinations of such polyols may also be used. The polyols may be based on a polyether chain derived from ethylene glycol, propylene glycol, butylene glycol, hexylene glycol and the like as well as mixtures thereof. The polyol may also be based on a polyester chain derived from ring opening polymerization of caprolactone (referred to as polycaprolactone-based polyols hereinafter). Suitable polyols may also include polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the diacids and anhydrides.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista. In addition, polyols based on dimer diols sold under the trade names Pripol®, Solvermol™ and Empol®, available from Cognis Corporation, or bio-based polyols, such as the tetrafunctional polyol Agrol 4.0, available from BioBased Technologies, may also be utilized.

The anhydride that may be used to form the epoxy-adduct may comprise any suitable acid anhydride known in the art. For example, the anhydride may comprise hexahydrophthalic anhydride and its derivatives (e.g., methyl hexahydrophthalic anhydride); phthalic anhydride and its derivatives (e.g., methyl phthalic anhydride); maleic anhydride; succinic anhydride; trimellitic anhydride; pyromelletic dianhydride (PMDA); 3,3′,4,4′-oxydiphthalic dianhydride (ODPA); 3,3′,4,4′-benzopherone tetracarboxylic dianhydride (BTDA); and 4,4′-diphthalic (hexafluoroisopropylidene) anhydride (6FDA).

The diacid used to form the epoxy-adduct may comprise any suitable diacid known in the art. For example, the diacids may comprise phthalic acid and its derivates (e.g., methyl phthalic acid), hexahydrophthalic acid and its derivatives (e.g., methyl hexahydrophthalic acid), maleic acid, succinic acid, adipic acid, and the like.

The epoxy-adduct may comprise a diol, a monoanhydride or a diacid, and a diepoxy compound, wherein the mole ratio of diol, monoanhydride (or diacid), and diepoxy compounds in the epoxy-adduct may vary from 0.5:0.8:1.0 to 0.5:1.0:6.0.

The epoxy-adduct may comprise a triol, a monoanhydride or a diacid, and a diepoxy compound, wherein the mole ratio of triol, monoanhydride (or diacid), and diepoxy compounds in the epoxy-adduct may vary from 0.5:0.8:1.0 to 0.5:1.0:6.0.

The epoxy-adduct may comprise a tetraol, a monoanhydride or a diacid, and a diepoxy compound, wherein the mole ratio of tetraol, monoanhydride (or diacid), and diepoxy compounds in the epoxy-adduct may vary from 0.5:0.8:1.0 to 0.5:1.0:6.0.

The molecule comprising an epoxide-functional group may have an epoxide functionality of at least 2, such as greater than 2, such as at least 2.1, such as at least 2.5, such as at least 3, such as at least 3.5, such as at least 4, such as at least 4.5, such as at least 5, such as at least 5.5, such as at least 6, such as at least 6.5, such as at least 7, such as at least 7.5, such as at least 8, such as at least 8.5, such as at least 9, such as at least 9.5, such as at least 10.

The epoxy-containing molecule may be a polymer. The polymeric epoxy-containing molecule may comprise an epoxy equivalent weight of at least 400 g/eq, such as at least 500 g/eq, such as at least 1,000 g/eq. The polymeric epoxy-containing molecule may have an epoxy equivalent weight of no more than 3,000 g/cq, such as no more than 2,500 g/cq, such as no more than 2,000 g/eq. The polymeric epoxy-containing molecule may have an epoxy equivalent weight of 400 g/eq to 3,000 g/eq, such as 500 g/eq to 2,000 g/eq, such as 1,000 g/eq to 2,000 g/eq.

The first component may comprise the epoxy-containing polymeric molecule in an amount up to 100 percent by weight based on total weight of the first component. The first component may comprise the epoxy-containing polymeric molecule in an amount of at least 0.5 percent by weight based on total weight of the first component, such as at least 1 percent by weight, such as at least 5 percent by weight, such as at least 10 percent by weight, such as at least 20 percent by weight, such as at least 30 percent by weight. The first component may comprise the epoxy-containing polymeric molecule in an amount of no more than 100 percent by weight based on total weight of the first component, such as no more than 90 percent by weight, such as no more than 80 percent by weight, such as no more than 70 percent by weight. The first component may comprise the epoxy-containing polymeric molecule in an amount of 0.5 percent by weight to 100 percent by weight based on total weight of the first component, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

The first component may comprise a small molecule comprising an epoxide-functional group. The epoxy-containing small molecule may have an epoxy equivalent weight of at least 70 g/eq, such as at least 75 g/eq, such as at least 90 g/eq. The epoxy-containing small molecule may have an epoxy equivalent weight of less than 400 g/eq, such as no more than 350 g/eq, such as no more than 300 g/eq. The epoxy-containing small molecule may have an epoxy equivalent weight of 70 g/eq to less than 400 g/eq, such as 75 g/eq to 350 g/eq, such as 90 g/eq to 300 g/eq.

The first component may comprise the epoxy-containing small molecule in an amount up to 100 percent by weight based on total weight of the first component. The first component may comprise the epoxy-containing small molecule in an amount of at least 0.5 percent by weight based on total weight of the first component, such as at least 1 percent by weight, such as at least 5 percent by weight, such as at least 10 percent by weight, such as at least 20 percent by weight, such as at least 30 percent by weight. The first component may comprise the epoxy-containing small molecule in an amount of no more than 100 percent by weight based on total weight of the first component, such as no more than 90 percent by weight, such as no more than 80 percent by weight, such as no more than 70 percent by weight. The first component may comprise the epoxy-containing small molecule in an amount of 0.5 percent by weight to 100 percent by weight based on total weight of the first component, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

The first component may comprise the epoxy-containing molecule in an amount up to 100 percent by weight based on total weight of the first component. The first component may comprise the epoxy-containing molecule in an amount of at least 0.5 percent by weight based on total weight of the first component, such as at least 1 percent by weight, such as at least 5 percent by weight, such as at least 10 percent by weight, such as at least 20 percent by weight, such as at least 30 percent by weight. The first component may comprise the epoxy-containing molecule in an amount of no more than 100 percent by weight based on total weight of the first component, such as no more than 90 percent by weight, such as no more than 80 percent by weight, such as no more than 70 percent by weight. The first component may comprise the epoxy-containing molecule in an amount of 0.5 percent by weight to 100 percent by weight based on total weight of the first component, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

The first component may comprise a polymeric epoxy-containing compound and a small molecule epoxy-containing compound.

The epoxy-containing molecule may have at least one functional group in addition to the epoxide functional group(s). Suitable examples of additional functional groups include hydroxide functional groups, silane functional groups, sulfide functional groups, and/or (meth)acrylate functional groups.

The epoxy-containing molecule may comprise a viscosity of from 1 mPa·s to 4,000 mPa·s at 298° K and 1 atm according to ASTM D789, such as for example, from 1 mPa·s to 3,000 mPa·s, 1 mPa·s to 2,000 mPa·s, 1 mPa·s to 1,000 mPa·s, 1 mPa·s to 100 mPa·s, or 2 mPa·s to 30 mPa·s.

The first component may comprise a viscosity of no more than 10⁶ Pa·s at a shear stress of 1 Hz measured by an Anton Paar MCR 301 rotational rheometer at 25 °C using a parallel plate with a diameter of 25 mm (1 mm gap), such as no more than 105 Pa·s, such as no more than 104 Pa·s, such as no more than 5,000 Pa·s, such as no more than 4,000 Pa·s, such as no more than 3,000 Pa·s, such as no more than 2,000 Pa·s, such as no more than 1,500 Pa·s, such as more than 100 Pa·s, such as more than 200 Pa·s, such as more than 500 Pa·s, such as 100 to 10⁶ Pa·s, such as 100 to 105 Pa·s, such as 100 to 104 Pa·s, such as 100 to 5,000 Pa·s, such as 100 to 4,000 Pa·s, such as 100 to 3,000 Pa·s, such as 100 to 2,000 Pa·s, such as 100 to 1,500 Pa·s, such as 200 to 10⁶ Pa·s, such as 200 to 105 Pa·s, such as 200 to 104 Pa·s, such as 200 to 5,000 Pa·s, such as 200 to 4,000 Pa·s, such as 200 to 3,000 Pa·s, such as 200 to 2,000 Pa·s, such as 200 to 1,500 Pa·s, such as 500 to 10⁶ Pa·s, such as 500 to 105 Pa·s, such as 500 to 104 Pa·s, such as 500 to 5,000 Pa·s, such as 500 to 4,000 Pa·s, such as 500 to 3,000 Pa·s, such as 500 to 2,000 Pa·s, such as 500 to 1,500 Pa·s.

### Molecules Comprising Thiol Functional Groups

The second component may comprise, or consist essentially of, or consist of, a molecule comprising a thiol functional group. The thiol-containing molecule may be monofunctional, difunctional, or polyfunctional. The molecule may be a monomer, a small molecule or a polymer. That is, the molecule may comprise a thiol-containing compound.

The second molecule may comprise a monothiol, a dithiol, or a polythiol compound. As used herein, a “monothiol molecule” refers to a molecule having one thiol functional group (—SH) per molecule, a “dithiol molecule” refers to a molecule having two thiol functional groups (—SH) per molecule, and a “polythiol molecule” refers to a molecule having more than two thiol functional groups (—SH) per molecule. Polythiol-containing molecules may comprise a trithiol, a tetrathiol, a pentathiol, a hexathiol or higher functional polythiol-containing molecules. The thiol-containing molecule may be used to “cure” the compositions disclosed herein by reacting with the epoxy-containing molecule to form a polymeric matrix.

Suitable monothiols useful in the compositions disclosed herein may include t-dodecane thiol, n-dodecyl mercaptan, p-toluenethiol, quinoline thiol, 1-thioglycerol, mercaptosuccinic acid, thiosalicylic acid, 2-aminoethanethiol, 2-thiocytosine, or combinations thereof.

Suitable polythiols useful in the compositions disclosed herein may include dithiols. Suitable diothiols include 3,6-dioxa-1,8-octanedithiol (DMDO), 3-oxa-1,5-pentanedithiol, 1,2-ethanedithiol, 1,3-propanedithiol, 1,2-propanedithiol, 1,4-butanedithiol, 1,3-butanedithiol, 2,3-butanedithiol, 1,5-pentanedithiol, 1,3-pentanedithiol, 1,6-hexanedithiol, 1,3-dithio-3-methylbutane, ethylcyclohexyldithiol (ECHDT), methylcyclohexyldithiol, methyl-substituted dimercaptodiethyl sulfide, dimethyl-substituted dimercaptodiethyl sulfide, 2,3-dimercapto-1-propanol, bis-(4-mercaptomethylphenyl) ether, 2,2′-thiodiethanethiol, and glycol dimercaptoacetate (commercially available as THIOCURE® GDMA from BRUNO BOCK Chemische Fabrik GmbH & Co. KG). Suitable trithiols include trimethylolpropane trimercaptoacetate (commercially available as THIOCURE® TMPMA from BRUNO BOCK Chemische Fabrik GmbH & Co. KG), trimethylopropane tris-3-mercaptopropionate (commercially available as THIOCURE® TMPMP from BRUNO BOCK Chemische Fabrik GmbH & Co. KG), ethoxylated trimethylpropane tris-3-mercaptopropionate polymer (commercially available as THIOCURE® ETTMP from BRUNO BOCK Chemische Fabrik GmbH & Co. KG), tris[2-(3-mercaptopropionyloxy)ethyl]isocyanurate (commercially available as THIOCURE® TEMPIC from BRUNO BOCK Chemische Fabrik GmbH & Co. KG). Suitable tetrathiols include pentaerythritol tetramercaptoacetate (commercially available as THIOCURE® PETMA from BRUNO BOCK Chemische Fabrik Gmbh & Co. KG), pentaerythritol tetra-3-mercaptopropionate (commercially available as THIOCURE® PETMP from BRUNO BOCK Chemische Fabrik GmbH & Co. KG), and polycaprolactone tetra(3-mercaptopropionate) (commercially available as THIOCURE® PCL4MP 1350 from BRUNO BOCK Chemische Fabrik GmbH & Co. KG). Higher functional polythiol-containing molecules may include dipentaerythritol hexa-3-mercaptopropionate (commercially available as THIOCURE® DiPETMP from BRUNO BOCK Chemische Fabrik GmbH & Co. KG). Combinations of polythiol-containing molecules may also be used.

The polythiol-containing molecule may comprise a mercaptan terminated polysulfide. Commercially available mercaptan terminated polysulfides include those sold under the trade name THIOKOL® LP from Toray Fine Chemicals Co., Ltd., including, but not limited to, LP-3, LP-33, LP-23, LP-980, LP-2, LP-32, LP-12, LP-31, LP-55 and LP-56. The THIOKOL LP mercaptan terminated polysulfides have the general structure HS—(C₂H₄—O—CH₂—O—C₂H₄—S—S)ₙC₂H₄—O—CH₂—O—C₂H₄—SH, wherein n is an integer of 5 to 50. Other commercially available mercaptan terminated polysulfides include those sold under the trade name THIOPLAST® G™ from Akzo Nobel Chemicals International B.V., including, but not limited to, G 10, G 112, G 131, G 1, G 12, G 21, G 22, G 44 and G 4. The THIOPLAST G mercaptan terminated polysulfides are blends of di- and tri-functional mercaptan-functional polysulfides with the di-functional unit having the structure HS—(R—S—S)ₙ—R—SH, wherein n is an integer from 7 to 38, and the tri-functional unit having the structure HS—(R—S—S)ₐ—CH₂—CH((S—S—R)_{c}—SH)—CH₂—(S—S—R)_{b}—SH, wherein a+b+c=n and n is an integer from 7 to 38.

The polythiol-containing molecule may comprise a mercaptan terminated polyether. Commercially available mercaptan terminated polyether include POLYTHIOL QE-340M available from Toray Fine Chemicals Co., Ltd., and Capcure 3-800 available from Gabriel Chemicals.

Suitable polyethers useful in the compositions include those polythioethers having a structure according to Formula (I):

—R¹[—S—(CH₂)₂—O—[R²—O]ₘ—(CH₂)₂—S—R¹]ₙ— (Formula I)
wherein
R¹ denotes a C₂₋₆ n-alkylene, C₃₋₆ branched alkylene, C₆₋₈cycloalkylene or C₆₋₁₀alkylcycloalkylene group, —[(CH₂)ₚ—X-]_{q}(CH₂)ᵣ, or —[(CH₂)ₚ—X-]_{q}(CH₂)ᵣ— in which at least one CH₂ unit is substituted with a methyl group,
R² denotes a C₂₋₆ n-alkylene, C₂₋₆ branched alkylene, C₆₋₈ cycloalkylene or C₆₋₁₀alkylcycloalkylene group, or -[(—CH₂—)ₚ—X-]_{q}—(—CH₂—)ᵣ—,
X denotes one selected from the group consisting of O, S and NR⁶,
R⁶ denotes H or methyl,
m is a rational number from 0 to 10,
n is an integer from 1 to 60,
p is an integer from 2 to 6,
q is an integer from 1 to 5, and
r is an integer from 2 to 10.

Polythioether polymers useful in the compositions disclosed herein may have a glass transition temperature T_{g} that is not higher than −50 °C, such as not higher than −55 °C, such as not higher than −60 °C. Low T_{g} is indicative of good low temperature flexibility, which can be determined by known methods, for example, by the methods described in AMS (Acrospace Material Specification) 3267 § 4.5.4.7, MIL-S (Military Specification)-8802E § 3.3.12 and MIL-S-29574, and by methods similar to those described in ASTM (American Society for Testing and Materials) D522-88.

Polythioethers useful in the compositions disclosed herein may have number average molecular weights of at least 500, such as at least 1,000, such as at least 2,000 and may have number average molecular weights of no more than 20,000, such as no more than 10,000, such as no more than 5,000. Polythioethers useful in the compositions disclosed herein may have number average molecular weights of 500 to 20,000, such as 1,000 to 10,000, such as 2,000 to 5,000 measured by gel permeation chromatography (GPC) using polystyrene standards and waters Styragel column in THF solvent.

Polythioether polymers useful in the compositions disclosed herein can be difunctional, that is, linear polymers having two end groups, or polyfunctional, that is, branched polymers having three or more end groups. Depending on the relative amounts of dithiol(s) and divinyl ether(s) used to prepare the polymers, the polymers can have terminal thiol groups (—SH) or terminal vinyl groups (—CH═CH₂). Furthermore, the polymers can be uncapped, that is, include thiol or vinyl terminal groups that are not further reacted, or capped, that is, include thiol or vinyl groups that are further reacted with other compounds. Capping the polythioethers enables introduction of additional terminal functionalities, for example, hydroxyl or amine groups, to the polymers, or in the alternative, introduction of end groups that resist further reaction, such as terminal alkyl groups.

For example, the polythioether may have the Formula (II):

A-([R³]_{y}—R⁴)₂ (Formula II)
wherein
A denotes a structure having the formula I,
y is 0 or 1,
R³ denotes a single bond when y=0 and —S—(CH₂)₂—[O—R²]ₘ—O— when y=1,
R⁴ denotes —SH or —S—(CH₂)₂₊ₛ—O—R⁵ when y=0 and —CH₂═CH₂ or —(CH₂)₂—S—
R⁵ when y=1,
s is an integer from 0 to 10,
R⁵ denotes C₁₋₆ n-alkyl which is unsubstituted or substituted with at least one —OH or —NHR⁷ group, and
R⁷ denotes H or a C₁₋₆ n-alkyl group.

Thus, polythioethers of the formula II are linear, difunctional polymers which can be uncapped or capped. When y=0, the polymer includes terminal thiol groups or capped derivatives thereof. When y=1, the polymer includes terminal vinyl groups or capped derivatives thereof.

For example, the polythioether may be a difunctional thiol-terminated (uncapped) polythioether. That is, in formula II, y=0 and R⁴ is —SH. Thus, the polythioether has the following structure:

HS—R¹[—S—(CH₂)₂—O—[R²—O-]ₘ(CH₂)₂—S—R¹]ₙ—SH.

The foregoing polymers are produced, for example, by reacting a divinyl ether or mixture thereof with an excess of a dithiol or mixture thereof, as discussed in detail below.

In another example of the foregoing polythioether, when m=1 and R²=n-butylene in formula II, R¹ is not ethylene or n-propylene. For example, when m=1, p=2, q=2, r=2 and R²=ethylene, X is not O.

In another example, the polythioether may be a capped polymer in which the foregoing terminal —SH groups are replaced by —S—(CH₂)₂₊ₛ—O—R⁵. Such caps are produced by reaction of the terminal thiol group with an alkyl @-alkenyl ether, such as a monovinyl ether, for example by including in the reaction mixture a capping agent or mixture thereof, as discussed in detail below.

In the foregoing, R⁵ denotes an unsubstituted or substituted alkyl group, such as a C₁₋₆ n-alkyl group which is unsubstituted or substituted with at least one —OH or —NHR⁷ group, with R⁷ denoting H or C₁₋₆ n-alkyl. Exemplary useful R⁵ groups include alkyl groups, such as ethyl, propyl and butyl; hydroxyl-substituted groups such as 4-hydroxybutyl; amine-substituted groups such as 3-aminopropyl; etc.

Polythioethers also include difunctional vinyl-terminated (uncapped) polythioethers. That is, in formula II, y=1 and R⁴ is-CH═CH₂. These polymers are produced, for example, by reacting a dithiol or mixture thereof with an excess of a divinyl ether or mixture thereof, as discussed in detail below. Analogous capped polythioethers include terminal-(CH₂)₂—S—R⁵.

The foregoing polythioethers are linear polymers having a functionality of 2 (considering alkyl and other non-reactive caps within this total). Polythioethers having higher functionality are also within the scope of the present disclosure. Such polymers are prepared, as discussed in detail below, by using a polyfunctionalizing agent. The term “polyfunctionalizing agent” as employed herein denotes a compound having more than two moieties that are reactive with terminal-SH and/or —CH═CH₂ groups. The polyfunctionalizing agent may include from 3 to 6 such moieties, and thus is denoted a “z-valent” polyfunctionalizing agent, where z is the number (such as from 3 to 6) of such moieties included in the agent, and hence the number of separate branches which the polyfunctional polythioether comprises. The polyfunctionalizing agent can be represented by the formula

B—(R⁸)_{z}

where R⁸ denotes a moiety that is reactive with terminal —SH or —CH═CH₂ and can be the same or different, and B is the z-valent residue of the polyfunctionalizing agent, i.e., the portion of the agent other than the reactive moieties R⁸.

Polyfunctional polythioethers according to the present disclosure thus may have the Formula (III):

B-(A—[R³]_{y}—R⁴)_{z} Formula III
wherein
A denotes a structure having the Formula I,
y is 0 or 1,
R³ denotes a single bond when y=0 and —S—(CH₂)₂[—O—R²]ₘ—O— when y=1,
R⁴ denotes —SH or —S—(CH₂)₂₊ₛ—O—R⁵ when y=0 and —CH₂═CH₂ or —(CH₂)₂—S—
R⁵ when y=1,
R⁵ denotes C₁₋₆ n-alkyl which is unsubstituted or substituted with at least one —OH or —NHR⁷ group,
R⁷ denotes H or a C₁₋₆ n-alkyl group,
z is an integer from 3 to 6, and
B denotes a z-valent residue of a polyfunctionalizing agent.

As with the preceding difunctional polythiolethers, the foregoing polyfunctional polythioethers can include terminal —SH or —CH═CH₂ groups or can be capped and thus include terminal —S—(CH₂)₂₊ₛ—O—R⁵ or —(CH₂)₂—S—R⁵ groups. Partially capped polyfunctional polymers, i.e., polymers in which some but not all of the branches are capped, are also within the scope of the present disclosure.

Specific polyfunctionalizing agents include trifunctionalizing agents, that is, compounds with z=3. Suitable trifunctionalizing agents include triallylcyanurate (TAC), which is reactive with compounds of the formula II (R⁸=allyl), and 1,2,3-propanetrithiol, which is reactive with compounds of the formula III (R⁸=—SH). Agents having mixed functionality, i.e., agents that include moieties (typically separate moieties) that react with both thiol and vinyl groups, can also be employed.

Other useful polyfunctionalizing agents include trimethylolpropane trivinyl ether, and the polythiols described in U.S. Pat. Nos. 4,366,307, 4,609,762 and 5,225,472, the disclosures of each of which are incorporated in their entireties herein by reference. Mixtures of polyfunctionalizing agents can also be used.

Polyfunctionalizing agents having more than three reactive moieties (i.e., z>3) afford “star”-shaped polythioethers and hyperbranched polythioethers. For example, two moles of TAC can be reacted with one mole of a dithiol to afford a material having an average functionality of 4. This material can then be reacted with a divinyl ether and a dithiol to yield a polymer, which can in turn be mixed with a trifunctionalizing agent to afford a polymer blend having an average functionality between 3 and 4.

Polythioethers as described above have a wide range of average functionality.

For example, trifunctionalizing agents afford average functionalities from 2.05 to 3.0, such as 2.1 to 2.6. Wider ranges of average functionality can be achieved by using tetrafunctional or higher polyfunctionalizing agents. Functionality will also be affected by factors such as stoichiometry, as is known to those skilled in the art.

Methods of making the foregoing polyfunctional polythioethers are discussed in detail in U.S. Pat. No. 6,172,179, 8:62-12:22, incorporated herein by reference.

The first molecule comprising a thiol-functional group may have an average thiol functionality of at least 2, such as greater than 2, such as at least 2.1, such as at least 2.5, such as at least 3, such as at least 3.5, such as at least 4, such as at least 4.5, such as at least 5, such as at least 5.5, such as at least 6, such as at least 6.5, such as at least 7, such as at least 7.5, such as at least 8, such as at least 8.5, such as at least 9, such as at least 9.5, such as at least 10.

The thiol-containing molecule may be a polymer. The polymeric thiol-containing molecule may comprise a thiol equivalent weight of at least 400 g/eq, such as at least 500 g/eq, such as at least 1,000 g/eq. The polymeric thiol-containing molecule may have a thiol equivalent weight of no more than 3,000 g/eq, such as no more than 2,500 g/eq, such as no more than 2,000 g/eq. The polymeric thiol-containing molecule may have a thiol equivalent weight of 400 g/eq to 3,000 g/eq, such as 500 g/eq to 2,000 g/eq, such as 1,000 g/eq to 2,000 g/eq.

The second component may comprise the polymeric thiol-containing molecule in an amount up to 100 percent by weight based on total weight of the second component. The second component may comprise the polymeric thiol-containing molecule in an amount of at least 0.5 percent by weight based on total weight of the second component, such as at least 1 percent by weight, such as at least 5 percent by weight, such as at least 10 percent by weight, such as at least 20 percent by weight, such as at least 30 percent by weight. The second component may comprise the polymeric thiol-containing molecule in an amount of no more than 100 percent by weight based on total weight of the second component, such as no more than 90 percent by weight, such as no more than 80 percent by weight, such as no more than 70 percent by weight. The second component may comprise the polymeric thiol-containing molecule in an amount of 0.5 percent by weight to 100 percent by weight based on total weight of the second component, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

The second component may comprise a small molecule comprising a thiol-functional group. The thiol-containing small molecule may have a thiol equivalent weight of at least 70 g/eq, such as at least 75 g/eq, such as at least 90 g/eq. The thiol-containing small molecule may have a thiol equivalent weight of less than 400 g/eq, such as no more than 350 g/eq, such as no more than 300 g/eq. The thiol-containing small molecule may have a thiol equivalent weight of 70 g/eq to less than 400 g/eq, such as 75 g/eq to 350 g/eq, such as 90 g/eq to 300 g/eq.

The second component may comprise the thiol-containing small molecule in an amount up to 100 percent by weight based on total weight of the second component. The second component may comprise the thiol-containing small molecule in an amount of at least 0.5 percent by weight based on total weight of the second component, such as at least 1 percent by weight, such as at least 5 percent by weight, such as at least 10 percent by weight, such as at least 20 percent by weight, such as at least 30 percent by weight. The second component may comprise the thiol-containing small molecule in an amount of no more than 100 percent by weight based on total weight of the second component, such as no more than 90 percent by weight, such as no more than 80 percent by weight, such as no more than 70 percent by weight. The second component may comprise the thiol-containing small molecule in an amount of 0.5 percent by weight to 100 percent by weight based on total weight of the second component, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

The second component may comprise a thiol-containing polymer and a thiol-containing small molecule.

The thiol-containing molecule may have at least one functional group in addition to the thiol functional group(s). Suitable examples of additional functional groups include a hydroxide functional group, a mercpto functional group, a silane functional group, a phenolic functional group and/or an amino functional group.

The thiol-containing molecule may comprise a viscosity of from 1 mPa·s to 4,000 mPa·s at 298° K and 1 atm according to ASTM D789, such as for example, from 1 mPa·s to 3,000 mPa·s, 1 mPa·s to 2,000 mPa·s, 1 mPa·s to 1,000 mPa·s, 1 mPa·s to 100 mPa·s, or 2 mPa·s to 30 mPa·s.

The second component may comprise a viscosity of no more than 10⁶ Pa·s at a shear stress of 1 Hz measured by an Anton Paar MCR 301 rotational rheometer at 25 °C using a parallel plate with a diameter of 25 mm (1 mm gap), such as no more than 105 Pa·s, such as no more than 104 Pa·s, such as no more than 5,000 Pa·s, such as no more than 4,000 Pa·s, such as no more than 3,000 Pa·s, such as no more than 2,000 Pa·s, such as no more than 1,500 Pa·s, such as more than 100 Pa·s, such as more than 200 Pa·s, such as more than 500 Pa·s, such as 100 to 10⁶ Pa·s, such as 100 to 105 Pa·s, such as 100 to 104 Pa·s, such as 100 to 5,000 Pa·s, such as 100 to 4,000 Pa·s, such as 100 to 3,000 Pa·s, such as 100 to 2,000 Pa·s, such as 100 to 1,500 Pa·s, such as 200 to 10⁶ Pa·s, such as 200 to 105 Pa·s, such as 200 to 104 Pa·s, such as 200 to 5,000 Pa·s, such as 200 to 4,000 Pa·s, such as 200 to 3,000 Pa·s, such as 200 to 2,000 Pa·s, such as 200 to 1,500 Pa·s, such as 500 to 10⁶ Pa·s, such as 500 to 105 Pa·s, such as 500 to 104 Pa·s, such as 500 to 5,000 Pa·s, such as 500 to 4,000 Pa·s, such as 500 to 3,000 Pa·s, such as 500 to 2,000 Pa·s, such as 500 to 1,500 Pa·s.

### Thermally Conductive Fillers

The compositions disclosed herein also may comprise fillers. The fillers may comprise a thermally conductive, electrically insulative filler (referred to herein as “TC/EI filler” and described in more detail below) and/or a thermally conductive, electrically conductive filler (referred to herein as “TC/EC filler” and described in more detail below). The TC/EI and/or TC/EC (referred to collectively as “thermally conductive fillers”) may be present in the first component, the second component and/or a third component. The thermally conductive fillers may comprise an organic or inorganic material and may comprise particles of a single type of filler material or may comprise particles of two or more types of TC/EI filler and/or two or more types of TC/EC filler. That is, the filler may comprise a first TC/EI filler and may further comprise at least a second (i.e., a second, a third, a fourth, etc.) TC/EI filler in addition to the first TC/EI filler. Likewise, the filler may comprise a first TC/EC filler and may further comprise at least a second (i.e., a second, a third, a fourth, etc.) TC/EC filler in addition to the first TC/EC filler. As used herein with respect to types of filler, reference to “first,” “second”, etc. is for convenience only and does not refer to order of addition to the composition or the like.

Optionally, any of the fillers may comprise a surface coating. The surface coating may comprise a silane, an amino-silane and/or a multidentate polymer.

The fillers may have a reported average particle size in at least one dimension of at least 0.01 μm, as reported by the manufacturer, such as at least 2 μm, such as at least 10 μm, and may have a reported average particle size in at least one dimension of no more than 500 μm as reported by the manufacturer, such as no more than 400 μm, such as no more than 300 μm, such as no more than 100 μm. The fillers may have a reported average particle size in at least one dimension of 0.01 μm to 500 μm as reported by the manufacturer, such as 0.1 μm to 400 μm, such as 2 μm to 300 μm, such as 10 μm to 100 μm. Particle sizes may be measured by methods known to those skilled in the art, for example, using a scanning electron microscope (SEM), such as a Quanta 250 FEG SEM or an equivalent instrument. For example, powders may be dispersed on segments of carbon tape attached to aluminum stubs and coated with Au/Pd for 20 seconds. Samples then may be analyzed in an SEM under high vacuum (accelerating voltage 10 kV and spot size 3.0), measuring 30 particles from three different areas to provide an average particle size for each sample. One skilled in the art will recognize that there can be variations in this procedure that retain the essential elements of microscopic imaging and averaging of representative size.

Thermally conductive filler may comprise particles each having, for example, a platy, spherical, or acicular shape, and agglomerates thereof. As used herein, “platy” refers to a two-dimensional material having a substantially flat surface and that has a thickness in one direction that is less than 25% of the largest dimension.

The thermally conductive filler (i.e., TC/EI and/or TC/EC fillers) may have a thermal conductivity of at least 5 W/m·K at 25 °C (measured according to ASTM D7984), such as at least 18 W/m·K, such as at least 55 W/m·K, and may have a thermal conductivity of no more than 3,000 W/m·K at 25 °C, such as no more than 1,400 W/m·K, such as no more than 450 W/m·K. The thermally conductive filler may have a thermal conductivity of 5 W/m·K to 3,000 W/m·K at 25 °C (measured according to ASTM D7984), such as 18 W/m·K to 1,400 W/m·K, such as 55 W/m·K to 450 W/m·K.

The filler may be electrically insulative. The electrically insulative filler may have a volume resistivity of at least 1 Ω·m (measured according to ASTM D257), such as at least 10 Ω·m, such as at least 100 Ω·m.

The filler may be electrically conductive. The electrically conductive filler may have a volume resistivity of less than 1 Ω·m (measured according to ASTM D257), such as less than 0.1 Ω·m.

Suitable TC/EI fillers include boron nitride (for example, commercially available as CarboTherm from Saint-Gobain, as CoolFlow and PolarTherm from Momentive, and as hexagonal boron nitride powder available from Panadyne), silicon nitride, or aluminum nitride (for example, commercially available as aluminum nitride powder available from Micron Metals Inc., and as Toyalnite from Toyal), metal oxides such as Boehmite, Pseudo Boehmite, aluminum oxide (for example, commercially available as Microgrit from Micro Abrasives, as Nabalox from Nabaltec, as Aeroxide from Evonik, and as Alodur from Imerys), magnesium oxide, beryllium oxide, titanium oxide, zinc oxide, nickel oxide, copper oxide, or tin oxide, metal hydroxides such as aluminum hydroxide or magnesium hydroxide, arsenides such as boron arsenide, carbides such as silicon carbide, minerals such as agate and emery, ceramics such as ceramic microspheres (for example, commercially available from Zeeospheres Ceramics or 3M), silicon carbide, and diamond. These fillers can also be surface modified, such as PYROKISUMA 5301K available from Kyowa Chemical Industry Co., Ltd. These thermally conductive fillers may be used alone or in a combination of two or more.

Suitable TC/EC fillers include metals such as silver, zinc, copper, gold, or metal coated hollow particles, carbon compounds such as, graphite (such as Timrex commercially available from Imerys or ThermoCarb commercially available from Asbury Carbons), carbon black (for example, commercially available as Vulcan from Cabot Corporation), carbon fibers (for example, commercially available as milled carbon fiber from Zoltek), graphene and graphenic carbon particles (for example, xGnP graphene nanoplatelets commercially available from XG Sciences, and/or for example, the graphene particles described below), carbonyl iron, copper (such as spheroidal powder commercially available from Sigma Aldrich), zinc (such as Ultrapure commercially available from Purity Zinc Metals and Zinc Dust XL and XLP available from US Zinc), and the like. Examples of “graphenic carbon particles” include carbon particles having structures comprising one or more layers of one-atom-thick planar sheets of sp2-bonded carbon atoms that are densely packed in a honeycomb crystal lattice. The average number of stacked layers may be less than 100, for example, less than 50. The average number of stacked layers may be 30 or less, such as 20 or less, such as 10 or less, such as 5 or less. The graphenic carbon particles may be substantially flat; however, at least a portion of the planar sheets may be substantially curved, curled, creased, or buckled. The particles typically do not have a spheroidal or equiaxed morphology. Suitable graphenic carbon particles are described in U.S. Publication No. 2012/0129980, at paragraphs [0059]-[0065], the cited portion of which is incorporated herein by reference. Other suitable graphenic carbon particles are described in U.S. Pat. No. 9,562,175, at 6:6 to 9:52, the cited portion of which are incorporated herein by reference. As used herein, the term “substantially flat” means planar; “curved” or “curled” materials deviate from planarity by having a non-zero curvature; and “creased” or “buckled” indicates that at least a portion of the area is thicker than one sheet, such that the plane is doubled or folded upon itself.

As discussed above, the thermally conductive filler may be present in the first component, the second component and/or the third component. The compositions disclosed herein may comprise thermally conductive filler in an amount of at least 50 percent by weight based on total weight of the composition, such as at least 51 percent by weight, such as at least 52 percent by weight, such as at least 53 percent by weight, such as at least 54 percent by weight, such as at least 55 percent by weight, such as at least 56 percent by weight, such as at least 57 percent by weight, such as at least 58 percent by weight, such as at least 59 percent by weight, such as at least 60 percent by weight, such as at least 61 percent by weight, such as at least 62 percent by weight, such as at least 63 percent by weight, such as at least 64 percent by weight, such as at least 65 percent by weight, such as at least 66 percent by weight, such as at least 67 percent by weight, such as at least 68 percent by weight, such as at least 69 percent by weight, such as at least 70 percent by weight. The compositions disclosed herein may comprise thermally conductive filler in an amount of no more than 90 percent by weight based on total weight of the composition, such as no more than 88 percent by weight. The compositions disclosed herein may comprise thermally conductive filler in an amount of 50 percent by weight to 90 percent by weight based on total weight of the composition, such as 51 percent by weight to 90 percent by weight, such as 52 percent by weight to 90 percent by weight, such as 53 percent by weight to 90 percent by weight, such as 54 percent by weight to 90 percent by weight, such as 55 percent by weight to 90 percent by weight, such as 56 percent by weight to 90 percent by weight, such as 57 percent by weight to 90 percent by weight, such as 58 percent by weight to 90 percent by weight, such as 59 percent by weight to 90 percent by weight, such as 60 percent by weight to 90 percent by weight, such as 61 percent by weight to 90 percent by weight, such as 62 percent by weight to 90 percent by weight, such as 63 percent by weight to 90 percent by weight, such as 64 percent by weight to 90 percent by weight, such as 65 percent by weight to 90 percent by weight, such as 66 percent by weight to 90 percent by weight, such as 67 percent by weight to 90 percent by weight, such as 68 percent by weight to 90 percent by weight, such as 69 percent by weight to 90 percent by weight, such as 60 percent by weight to 88 percent by weight, such as 61 percent by weight to 88 percent by weight, such as 62 percent by weight to 88 percent by weight, such as 63 percent by weight to 88 percent by weight, such as 64 percent by weight to 88 percent by weight, such as 65 percent by weight to 88 percent by weight, such as 66 percent by weight to 88 percent by weight, such as 67 percent by weight to 88 percent by weight, such as 68 percent by weight to 88 percent by weight, such as 69 percent by weight to 88 percent by weight, such as 70 percent by weight to 88 percent by weight.

The thermally conductive filler may comprise thermally stable filler and/or thermally unstable filler.

In an example, a portion of the thermally conductive filler may be thermally stable. For example, up to 100 percent by weight of the thermally conductive filler may be thermally stable based on total weight of the thermally conductive filler, such as at least 0.1 percent by weight, such as at least 1 percent by weight, such as at least 10 percent by weight such as at least 15 percent by weight, such as at least 20 percent by weight, such as at least 25 percent by weight, such as at least 30 percent by weight, such as at least 35 percent by weight, such as at least 40 percent by weight, such as at least 45 percent by weight, such as at least 50 percent by weight, such as at least 55 percent by weight, such as at least 60 percent by weight, such as at least 65 percent by weight, such as at least 70 percent by weight, such as least 75 percent by weight, such as at least 80 percent by weight, such as at least 85 percent by weight, such as at least 90 percent by weight, such as at least 91 percent by weight, such as at least 92 percent by weight, such as at least 93 percent by weight, such as at least 94 percent by weight, such as at least 95 percent by weight, such as at least 96 percent by weight, such as at least 97 percent by weight, such as at least 98 percent by weight, such as at least 99 percent by weight, such as 100 percent by weight. For example, 0.1 percent by weight to 100 percent by weight of the thermally conductive filler may be thermally stable based on total weight of the thermally conductive filler, such as 1 percent by weight to 90 percent by weight, such as 10 percent by weight to 80 percent by weight, such as 20 percent by weight to 70 percent by weight, such as 30 percent by weight to 60 percent by weight, such as 90 percent by weight to 100 percent by weight, such as 93 percent by weight to 98 percent by weight.

A portion of thermally conductive filler may be thermally unstable. For example, up to 100 percent by weight of the thermally conductive filler may be thermally unstable based on total weight of the thermally conductive filler, such as at least 0.1 percent by weight, such as at least 1 percent by weight, such as at least 10 percent by weight such as at least 15 percent by weight, such as at least 20 percent by weight, such as at least 25 percent by weight, such as at least 30 percent by weight, such as at least 35 percent by weight, such as at least 40 percent by weight, such as at least 45 percent by weight, such as at least 50 percent by weight, such as at least 55 percent by weight, such as at least 60 percent by weight, such as at least 65 percent by weight, such as at least 70 percent by weight, such as least 75 percent by weight, such as at least 80 percent by weight, such as at least 85 percent by weight, such as at least 90 percent by weight, such as at least 91 percent by weight, such as at least 92 percent by weight, such as at least 93 percent by weight, such as at least 94 percent by weight, such as at least 95 percent by weight, such as at least 96 percent by weight, such as at least 97 percent by weight, such as at least 98 percent by weight, such as at least 99 percent by weight, such as 100 percent by weight. For example, 0.1 percent by weight to 100 percent by weight of the thermally conductive filler may be thermally unstable based on total volume of the thermally conductive filler, such as 1 percent by weight to 90 percent by weight, such as 10 percent by weight to 80 percent by weight, such as 20 percent by weight to 70 percent by weight, such as 30 percent by weight to 60 percent by weight, such as 90 percent by weight to 100 percent by weight, such as 93 percent by weight to 98 percent by weight. In other examples, no more than 10 percent by weight of the thermally conductive filler may be thermally unstable based on total volume of the thermally conductive filler, such as no more than 9 percent by weight, such as no more than 8 percent by weight, such as no more than 7 percent by weight, such as no more than 6 percent by weight, such as no more than 5 percent by weight, such as no more than 4 percent by weight, such as no more than 3 percent by weight, such as no more than 2 percent by weight, such as no more than 1 percent by weight. For example, up to 10 percent by weight of the thermally conductive filler may be thermally unstable based on total volume of the thermally conductive filler, such as 2 percent by weight to 7 percent by weight.

Suitable thermally stable, thermally conductive fillers include boron nitride, silicon nitride, or aluminum nitride, arsenides such as boron arsenide, metal oxides such as aluminum oxide, magnesium oxide, beryllium oxide, silicon dioxide, titanium oxide, zinc oxide, nickel oxide, copper oxide, or tin oxide, carbides such as silicon carbide, minerals such as agate and emery, ceramics such as ceramic microspheres, and diamond. The silica (SiO₂) may comprise fumed silica which comprises silica that has been treated with a flame to form a three-dimensional structure. The fumed silica may be untreated or surface treated with a siloxane, such as, for example, polydimethylsiloxane. Exemplary non-limiting commercially available fumed silica includes products solder under the trade name AEROSIL®, such as AEROSIL® R 104, AEROSIL® R 106, AEROSIL® R 202, AEROSIL® R 208, AEROSIL® R 972 commercially available from Evonik Industries and products sold under the trade name HDK® such as HDK® H17 and HDK® H18 commercially available from Wacker Chemie AG. These fillers can also be surface modified, such as PYROKISUMA 5301K available from Kyowa Chemical Industry Co., Ltd. These thermally stable, thermally conductive fillers may be used alone or in a combination of two or more.

Suitable thermally unstable, thermally conductive filler materials include metal hydroxides such as aluminum trihydrate, aluminum hydroxide or magnesium hydroxide. These fillers can also be surface modified, such as Hymod®M9400 SF available from J.M. Huber Corporation. These thermally unstable, thermally conductive fillers may be used alone or in a combination of two or more.

### Thermally Expandable Material

The composition of the present disclosure may comprise a thermally expandable material. The thermally expandable material may be present in the first component, the second component, and/or a third component.

The thermally expandable material may comprise thermally expandable capsules. The thermally expandable capsules may comprise thermally expandable hollow capsules. The thermally expandable capsules may comprise a thermoplastic resin and/or a volatile material such as a volatile hydrocarbon and/or a volatile gas.

The thermally expandable material may have a pre-expansion D50 particle size of at least at least 1 μm measured by methods known to those skilled in the art, such as laser diffraction or Low Angle Laser Light Scattering (LALLS), such as at least 2 μm, such as at least 3 μm, such as at least 5 μm, such as at least 10 μm. The thermally expandable material may have a pre-expansion D50 particle size of no more than 100 μm, such as no more than 80 μm, such as no more than 60 μm, such as no more than 50 μm. The thermally expandable material may have a pre-expansion D50 particle size of 0.5 μm to 100 μm, such as 1 μm to 80 μm, such as 2 μm to 60 μm, such as 3 μm to 50 μm, such as 5 μm to 50 μm, such as 10 μm to 50 μm.

The thermally expandable material may have an expansion onset temperature of at least 60 °C, such as at least 70 °C, such as at least 80 °C, such as at least 90 °C, such as at least 100 °C, such as at least 110 °C, such as at least 120 °C, such as at least 130 °C, such as at least 140 °C, such as at least 150 °C, such as at least 160 °C, such as at least 170 °C, such as at least 180 °C, such as at least 190 °C, such as at least 200 °C.

Following exposure to at least the expansion onset temperature, the thermally expandable material may have an expansion volume ratio of at least 1.5 such as at least 2, such as at least 2.5, such as at least 3, such as at least 4, such as at least 5, such as at least 10, such as at least 20, such as at least 50, such as at least 75, such as at least 100, such as at least 125, such as at least 175, such as at least 200.

Suitable thermally expandable materials comprise Expancel available from Nouryon, Advancell available from Sekisui, and the like.

The composition may comprise the thermally expandable material in an amount of at least 0.5 percent by weight based on total weight of the composition, such as at least 0.75 percent by weight, such as at least 1 percent by weight. The composition may comprise the thermally expandable material in an amount of no more than 10 percent by weight based on total weight of the composition, such as no more than 7 percent by weight, such as no more than 3 percent by weight. The composition may comprise the thermally expandable material in an amount of 0.5 percent to 10 percent by weight based on total weight of the composition, such as 0.75 percent to 7 percent by weight, such as 1 percent to 3 percent by weight.

### Non-Thermally Conductive Fillers

The compositions disclosed herein also may comprise non-thermally conductive, electrically insulative filler (referred to herein as “NTC/EI” filler). As used herein, the NTC/EI filler is in addition to the thermally expandable materials described above. The NTC/EI filler may be present in the first component, the second component and/or a third component. The NTC/EI filler may comprise an organic or inorganic material and may comprise particles of a single type of filler material or may comprise particles of two or more types of NTC/EI filler. That is, the composition may comprise a first NTC/EI filler and may further comprise at least a second (i.e., a second, a third, a fourth, etc.) NTC/EI filler in addition to the first NTC/EI filler.

The NTC/EI filler may comprise any of the surface coatings and may be the particle sizes described above with respect to the thermally conductive fillers. The NTC/EI filler may comprise particles each having, for example, a platy, spherical, or acicular shape, and agglomerates thereof, as described above with respect to the thermally conductive fillers.

The non-thermally conductive filler may have a thermal conductivity of less than 5 W/m·K at 25 °C (measured according to ASTM D7984), such no more than 3 W/m·K, such as no more than W/m·K, such as no more than 0.1 W/m·K, such as no more than 0.05 W/m·K, such as 0.02 W/m·K at 25 °C to 5 W/m·K at 25 °C. Thermal conductivity may be measured as described above.

The non-thermally conductive filler may be electrically insulative. The electrically insulative filler may have a volume resistivity of at least 1 Ω·m (measured according to ASTM D257), such as at least 10 Ω·m, such as at least 100 Ω·m.

Suitable NTC/EI fillers include but are not limited to mica, wollastonite, calcium carbonate, glass microspheres, clay, silicon dioxide, or combinations thereof.

As used herein, the term “mica” generally refers to sheet silicate (phyllosilicate) minerals. The mica may comprise muscovite mica. Muscovite mica comprises a phyllosilicate mineral of aluminum and potassium with the formula KAl₂(AlSi₃O₁₀)(F,OH)₂ or (KF)₂(Al₂O₃)₃(SiO₂)₆(H₂O). Exemplary non-limiting commercially available muscovite mica include products sold under the trade name DakotaPURE™, such as DakotaPURE™ 700, DakotaPURE™ 1500, DakotaPURE™ 2400, DakotaPURE™ 3000, DakotaPURE™ 3500 and DakotaPURE™ 4000, available from Pacer Minerals. Wollastonite comprises a calcium inosilicate mineral (CaSiO₃) that may contain small amounts of iron, aluminum, magnesium, manganese, titanium and/or potassium. The wollastonite may have a B.E.T. surface area of 1.5 to 2.1 m²/g, such as 1.8 m²/g and a median particle size of 6 microns to 10 microns, such as 8 microns. Non-limiting examples of commercially available wollastonite include NYAD 400 available from NYCO Minerals, Inc.

The calcium carbonate (CaCO₃) may comprise a precipitated calcium carbonate or a ground calcium carbonate. The calcium carbonate may or may not be surface treated, such as treated with stearic acid. Non-limiting examples of commercially available precipitated calcium carbonate include Ultra-Pflex®, Albafil®, and Albacar HOR available from Specialty Minerals and Winnofil® SPT available from Solvay. Non-limiting examples of commercially available ground calcium carbonate include Duramite™ available from IMERYS and Marblewhite® available from Specialty Minerals.

Useful clay minerals include a non-ionic platy filler such as talc, pyrophyllite, chlorite, vermiculite, or combinations thereof.

The glass microspheres may be hollow borosilicate glass. Non-limiting examples of commercially available glass microspheres include 3M Glass bubbles type VS, K series, and S series available from 3M.

As discussed above, NTC/EI filler may be present in the first component, the second component and/or the third component or higher component. The compositions disclosed herein may comprise NTC/EI filler in an amount of at least 0.5 percent by weight based on total weight of the composition, such as at least 1 percent by weight, such as at least 1.5 percent by weight. The compositions disclosed herein may comprise NTC/EI filler in an amount of no more than 30 percent by weight based on total weight of the composition, such as no more than 20 percent by weight, such as no more than 10 percent by weight. The compositions disclosed herein may comprise NTC/EI filler in an amount of up to 30 percent by weight based on total weight of the composition, such as 0.5 percent by weight to 30 percent by weight, such as 1 percent by weight to 20 percent by weight, such as 1.5 percent by weight to 10 percent by weight.

### Accelerators

The disclosed compositions optionally may comprise an accelerator. As used herein, “accelerator” means a substance that increases the rate or decreases the activation energy of a chemical reaction. An accelerator may be either a “catalyst,” that is, without undergoing any permanent chemical change, or may be a “curing agent” which is reactive, that is, capable of chemical reactions (i.e., crosslinking) and includes any level of reaction from partial to complete reaction of a reactant.

The accelerator may be an amine-based catalyst. The accelerator may be a cyclic tertiary amine, an aromatic amine, an acid-blocked amine or combinations thereof. The accelerator may be a cyclic tertiary amine, an aromatic amine, or combinations thereof.

Useful accelerators include as trimethylamine; tributylamine; N,N-bis(N,N-dimethyl-2-aminoethyl)methylamine; N,N-dimethylcyclohexylamine; N-methylmorpholine; N-ethylmorpholine; piperidine; piperazine; pyrrolidine; homopiperazine; 1,2-dimethyl-1,4,5,6-tetrahydropyrimidine; 1,4,5,6-tetrahydropyrimidine; 1,8-diazabicyclo[5.4.0]undec-7-ene; 1,5,7-triazabicyclo[4.4.0]dec-5-ene; 7-methyl-1,5,7-triazabicyclo[4.4.0]dec-5-ene; 1,5-diazabicyclo[4.3.0]non-5-ene; 6-(dibutylamino)-1,8-diazabicyclo(5,4,0) undec-7-ene; 1,4-diazabicyclo[2.2.2]octane; 7-azabicyclo[2.2.1]heptane; N, N-dimethylphenylamine; 4,5-dihydro-1H-imidazole; and guanidine-based catalysts such as guanidine, methylguanidine, dimethylguanidine, trimethylguanidine, tetramethylguanidine, pentamethylguanidine, methylisobiguanidine, dimethylisobiguanidine, tetramethylisobiguanidine, hexamethylisobiguanidine, heptamethylisobiguanidine, phenylguanidine, diphenylguanidine, butylbiguanide, 1-o-tolylbiguanide, 1-phenylbiguanide, 1-methyl-3-nitroguanidine, 1,8-bis(tetramethylguanidino)-naphthalene, and N,N,N′,N′-tetramethyl-N″-[4-morpholinyl(phenylimino)methyl]guanidine. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide, e.g., Dyhard® available from AlzChem). Representatives of suitable guanamine derivatives which may be mentioned are alkylated benzoguanamine resins, benzoguanamine resins or methoxymethylethoxymethylbenzoguanamine.

The accelerator may comprise azoles, diazoles, triazoles, higher functional azoles, and combinations thereof. Suitable alkaloid compounds include pyrrolidine, tropane, pyrrolizidine, piperidine, quinolizidine, indolizidine, pyridine, isoquinoline, oxazole, isoxazole, thiazole, quinazoline, acridine, quinoline, indole, imidazole, purine, phenethylamine, muscarine, benzylamines, derivatives of these alkaloid compounds, or combinations thereof.

In other examples, the accelerator may comprise amidoamine or polyamide catalysts, such as, for example, one of the Ancamide® products available from Air Products, amine (such as DY9577 boron complex, ARDUR HT 973, and ARDUR 1167 available from Huntsman Advanced Materials), dihydrazide, or dicyandiamide adducts and complexes, such as, for example, one of the Ajicure® products available from Ajinomoto Fine Techno Company, 3,4-dichlorophenyl-N,N-dimethylurea (A.K.A. Diuron) available from Alz Chem, or may comprise an acid-blocked amine such as the Niax* catalysts available from Momentive Performance Materials, Inc., or combinations thereof.

The compositions disclosed herein may comprise the accelerator in an amount of at least 0.01 percent by weight based on total weight of the composition, such as at least 0.1 percent by weight, such as at least 1 percent by weight. The compositions disclosed herein may comprise the accelerator in an amount of no more than 5 percent by weight based on total weight of the composition, such as no more than 4 percent by weight, such as no more than 3 percent by weight. The compositions disclosed herein may comprise the accelerator in an amount of 0.01 percent by weight to 5 percent by weight based on total weight of the composition, such as 0.1 percent by weight to 4 percent by weight, such as 1 percent by weight to 3 percent by weight.

The composition may be substantially free, or essentially free, or completely free, of latent accelerator. For example, a latent accelerator may be in the form of a solid at room temperature and have no catalytic effect or reactivity until it is heated and melts, or the latent accelerator may comprise a molecule reversibly reacted with a second compound that prevents any crosslinking or catalytic effect until the reversible reaction is reversed by the application of heat and the second compound is removed, freeing the molecule to crosslink or catalyze reactions.

### Dispersants

The composition optionally may further comprise a dispersant. As used herein, the term “dispersant” refers to a substance that may be added to the composition in order to improve the separation of the thermally conductive filler particles by wetting the particles and breaking apart agglomcrates.

Suitable dispersants for use in the composition include fatty acid, phosphoric acid esters, polyurethanes, polyamines, polyacrylates, polyalkoxylates, sulfonates, polyethers, and polyesters, or any combination thereof. Non-limiting examples of commercially available dispersants include ANTI-TERRA-U100, DISPERBYK-102, DISPERBYK-103, DISPERBYK-111, DISPERBYK-171, DISPERBYK-2151, DISPERBYK-2152, DISPERBYK-2059, DISPERBYK-2000, DISPERBYK-2117, and DISPERBYK-2118 available from BYK Company; and SOLSPERSE 24000SC, SOLSPERSE 16000 and SOLSPERSE 8000 hyperdispersants available from The Lubrizol Corporation, and Tegowet 270, Tegowet 500, TEOG® Dispers 670, and Tegowet 550 available from Evonik.

The composition may comprise a dispersant in an amount of at least 0.5 percent by weight based on total weight of the composition, such as at least 1 percent by weight. The composition may comprise a dispersant in an amount of no more than 10 percent by weight based on total weight of the composition, such as no more than 5 percent by weight. The composition may comprise a dispersant in an amount of more than 0 percent by weight to 10 percent by weight based on total weight of the composition, such as 0.5 percent by weight to 10 percent by weight, such as 1 percent by weight to 5 percent by weight.

### Additives

The composition may comprise an additive. Additives may be present in the first component, the second component and/or the third or higher components of the composition. Suitable examples of additives include a rheology modifier, a tackifier, a thermoplastic polymer, a UV stabilizer, a colorant, a tint, a plasticizer, an antioxidant, a pigment, a silane, a surface active agent (other than the reactive diluent described above), a flame retardant, a corrosion inhibitor, an adhesion promoter (other than the epoxy-containing small molecule and/or the thiol-containing small molecule described above), a moisture scavenger, a coupling agent, silica, a potlife extender, or combinations thereof.

As used herein, “coupling agent” refers to a compound which provides a chemical bond between two dissimilar materials, such as an inorganic and an organic. Suitable examples include but are not limited to organosilanes, titanates such as isopropoxytri (ethylaminoethylamino) titanate, zirconates, 1,2 diketones, nitrogen heterocyclic compounds, cobalt compounds, and combinations thereof.

As used herein, “potlife extenders” are chemicals that allow components to be mixed together while extending the time to cure. Suitable examples include thiols, acetylacetone, 3,5-dimethylpyrazole and combinations thereof.

Useful rheology modifiers that may be used include polyamide, amide waxes, polyether phosphate, oxidized polyolefin, Castor wax and organoclay. Commercially available thixotropes useful in the present disclosure include Disparlon 6500 available from King Industries, Garamite 1958 available from BYK Company, Bentone SD2 and Thixatrol®ST available from Elementis, and Crayvallac SLX available from Palmer Holland.

Useful colorants or tints may include phthalocyanine blue.

The composition optionally may comprise at least one plasticizer. Examples of plasticizers include diisononylphthalate (Jayflex™ DINP available from Exxon Mobil), diisodecylphthalate (Jayflex™ DIDP available from Exxon Mobil), and alkyl benzyl phthalate (Santicizer 278 available from Valtris); benzoate-based plasticizers such as dipropylene glycol dibenzoate (K-Flex® available from Emerald Performance Materials); and other plasticizers including terephthalate-based dioctyl terephthalate (DEHT available from Eastman Chemical Company), alkylsulfonic acid ester of phenol (Mesamoll available from Borchers), and 1,2-cyclohexane dicarboxylic acid diisononyl ester (Hexamoll DINCH available from BASF). Other plasticizers may include isophthalic hydrogenated terphenyls, quarterphenyls and higher or polyphenyls, phthalate esters, chlorinated paraffins, modified polyphenyl, naphthalene sulfonates, trimellitates, adipates, sebacates, maleates, sulfonamide, organophosphates, polybutene, and combinations of any of the foregoing. These plasticizers can be polymers such as polyacrylates.

Examples of suitable corrosion inhibitors include, for example, zinc phosphate-based corrosion inhibitors, for example, micronized Halox® SZP-391, Halox® 430 calcium phosphate, Halox® ZP zinc phosphate, Halox® SW-111 strontium phosphosilicate Halox® 720 mixed metal phosphor-carbonate, and Halox® 550 and 650 proprietary organic corrosion inhibitors commercially available from Halox. Other suitable corrosion inhibitors include Heucophos® ZPA zinc aluminum phosphate and Heucophos® ZMP zinc molybdenum phosphate, commercially available from Heucotech Ltd.

A corrosion inhibitor can comprise a lithium silicate such as lithium orthosilicate (Li₄SiO₄) and lithium metasilicate (Li₂SiO₃), MgO, an azole, or a combination of any of the foregoing. The corrosion inhibiting component may further comprise at least one of magnesium oxide (MgO) and an azole.

A corrosion inhibitor can comprise a monomeric amino acid, a dimeric amino acid, an oligomeric amino acid, or a combination of any of the foregoing. Examples of suitable amino acids include histidine, arginine, lysine, cysteine, cystine, tryptophan, methionine, phenylalanine, tyrosine, and combinations of any of the foregoing.

A corrosion inhibitor can comprise a nitrogen-containing heterocyclic compound. Examples of such compounds include azoles, oxazoles, thiazoles, thiazolines, imidazoles, diazoles, pyridines, indolizines, and triazines, tetrazoles, tolyltriazole, and combinations of any of the foregoing.

Examples of suitable triazoles include 1,2,3-triazole, 1,2,4-triazole, benzotriazole, derivatives thereof, and combinations of any of the foregoing. Derivatives of 1,2,3-triazole include 1-methyl-1,2,3-triazole, 1-phenyl-1,2,3-triazole, 4-methyl-2-phenyl-1,2,3-triazole, 1-benzyl-1,2,3-triazole, 4-hydroxy-1,2,3-triazole, 1-amino-1,2,3-triazole, 1-benzamido-4-methyl-1,2,3-triazole, 1-amino-4,5-diphenyl-1,2,3-triazole, 1,2,3-triazole aldehyde, 2-methyl-1,2,3-triazole-4-carboxylic acid, and 4-cyano-1,2,3-triazole, or combinations thereof. Derivatives of 1,2,4-triazole include 1-methyl-1,2,4-triazole, 1,3-diphenyl-1,2,4-triazole, 5-amino-3-methyl-1,2,4-triazole, 3-mercapto-1,2,4-triazole, 1,2,4-triazole-3-carboxylic acid, 1-phenyl-1,2,4-triazole-5-one, 1-phenylurazole, and combinations of any of the foregoing. Examples of diazoles include 2,5-dimercapto-1,3,4-thiadiazole.

A corrosion inhibitor can include an azole or combination of azoles. Azoles are 5-membered N-heterocyclic compounds that contain in the heterocyclic ring two double bonds, one to three carbon atoms and optionally a sulfur or oxygen atom. Examples of suitable azoles include benzotriazole, 5-methyl benzotriazole, tolyltriazole, 2,5-dimercapto-1,3,4-thiazole, 2-mercaptobenzothiazole, 2-mercaptobenzimidazole, 1-phenyl-5-mercaptotetrazole, 2-amino-5-mercapto-1,3,4-thiadiazole, 2-mercapto-1-methylimidazole, 2-amino-5-ethyl-1,3,4-thiadiazole, 2-amino-5-ethylthio-1,3,4-thiadiazole, 5-phenyltetrazole, 7H-imidazo (4,5-d)pyrimidine, and 2-amino thiazole. Salts of any of the foregoing, such as sodium and/or zinc salts, can also be used as effective corrosion inhibitors. Other suitable azoles include 2-hydroxybenzothiazole, benzothiazole, 1-phenyl-4-mcthylimidazole, and 1-(p-tolyl)-4-mcthlyimidazolc.

Useful rheology modifiers that may be used include polyamide, amide waxes, polyether phosphate, oxidized polyolefin, Castor wax and organoclay. Commercially available thixotropes useful in the present disclosure include Disparlon 6500 available from King Industries, Garamite 1958 available from BYK Company, Bentone SD2 and Thixatrol®ST available from Elementis, and Crayvallac SLX available from Palmer Holland.

Compositions provided by the present disclosure can comprise a flame retardant or combination of flame retardants. Certain thermally conductive fillers described above such as aluminum hydroxide and magnesium hydroxide, for example, also may be flame retardants. As used herein, “flame retardant” refers to a material that slows down or stops the spread of fire or reduces its intensity. Flame retardants may be available as a powder that may be mixed with a composition, a foam, or a gel. In examples, when the compositions disclosed herein include a flame retardant, such compositions may form a coating on a substrate surface and such coating may function as a flame retardant.

As set forth in more detail below, a flame retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

Suitable moisture scavengers include vinyltrimethoxysilane (Silquest A-171 from Momentive), vinyltriethoxysilane (Silquest A-151NT from Momentive), gamma-methacryloxypropyltrimethoxysilane (Silquest A-174NT available from Evonik), molecular sieves, calcium oxide (POLYCAL OS325 available from Mississippi Lime), or combinations thereof.

The composition may comprise the additives in a total amount of greater than 0 percent by weight based on total weight of the composition, such as at least 1 percent by weight, such as at least 2 percent by weight, such as at least 5 percent by weight. The composition may comprise the additives in a total amount of no more than 15 percent by weight based on total weight of the composition, such as no more than 10 percent by weight. The composition may comprise the additives in a total amount of more than 0 percent by weight to 15 percent by weight based on total weight of the composition, such as 1 percent by weight to 15 percent by weight, such as 2 percent by weight to 10 percent by weight, such as 5 percent by weight to 10 percent by weight.

### Compositions, Systems and Methods

The 2K compositions disclosed herein may comprise, or may consist essentially of, or may consist of: a first component comprising, or consisting essentially of, or consisting of, a first molecule comprising an epoxide functional group; a second component comprising, or consisting essentially of, or consisting of, a second molecule comprising a thiol functional group; a thermally expandable material; and a thermally conductive filler; wherein the epoxide functional group and the thiol functional group are reactive under ambient conditions. The first molecule comprising the epoxide functional group may be a polymer, a small molecule, or combinations thereof. The second molecule comprising the thiol functional group may be a polymer, a small molecule, or combinations thereof. The first component and/or the second component each may comprise the thermally expandable material and/or the thermally conductive filler. The first component may further comprise epoxy-containing molecules in addition to the first molecule and/or an additive. The second component may further comprise thiol-containing molecules in addition to the second molecule, an accelerator, and/or an additive.

The 3K compositions disclosed herein may comprise, or may consist essentially of, or may consist of: a first component comprising, or consisting essentially of, or consisting of, a first molecule comprising an epoxide functional group; a second component comprising, or consisting essentially of, or consisting of, a second molecule comprising a thiol functional group; a thermally expandable material; and a thermally conductive filler; wherein the epoxide functional group and the thiol functional group are reactive under ambient conditions. The first molecule comprising the epoxide functional group may be a polymer, a small molecule, or combinations thereof. The second molecule comprising the thiol functional group may be a polymer, a small molecule, or combinations thereof. The first component, the second component, and/or a third component each may comprise the thermally expandable material and the thermally conductive filler. The first component may further comprise epoxy-containing molecules in addition to the first molecule and/or an additive. The second component may further comprise thiol-containing molecules in addition to the second molecule, an accelerator, and/or an additive. A third component may comprise additional epoxy-containing molecules, additional thiol-containing molecules, an accelerator, and/or any of the additives described herein above.

The compositions disclosed herein may comprise the thiol-containing molecule in an amount such that an equivalence ratio of thiol groups to epoxide groups is at least 1:4, such as at least 1:3, such as at least 1:2. The compositions disclosed herein may comprise the thiol-containing molecule in an amount such that an equivalence ratio of thiol groups to epoxide groups is no more than 4:1, such as no more than 3:1, such as no more than 2:1. The compositions disclosed herein may comprise the thiol-containing molecule in an amount such that an equivalence ratio of thiol groups to epoxide groups is 1:4 to 4:1, such as 1:3 to 3:1, such as 1:2 to 2:1.

The composition may have a total solids content of at least 90 percent by weight based on total weight of the composition, such as at least 91 percent by weight, such as at least 92 percent by weight, such as at least 93 percent by weight, such as at least 94 percent by weight, such as at least 95 percent by weight, such as at least 96 percent by weight, such as at least 97 percent by weight, such as at least 98 percent by weight, such as at least 99 percent by weight, such as 100 percent by weight. As used herein, “total solids” refers to the non-volatile content of the composition, i.e., materials which will not volatilize when heated to 105 °C and standard atmospheric pressure (101325 Pa) for 60 minutes.

The composition may comprise the first molecule and the second molecule in a total amount of at least 9.5 percent by weight based on total weight of the composition, such as at least 15 percent by weight. The composition may comprise the first molecule and the second molecule in a total amount of no more than 90 percent by weight based on total weight of the composition, such as no more than 80 percent by weight. The composition may comprise the first molecule and the second molecule in a total amount of 9.5 percent by weight to 90 percent by weight based on total weight of the composition, such as 15 percent by weight to 80 percent by weight.

The composition may be substantially free, or essentially free, or completely free, of solvent.

Also disclosed herein are methods for preparing one of the compositions disclosed above. The method optionally may comprise mixing an epoxy-containing molecule with any of the optional ingredients that may be included in the first component to form the first component comprising a mixture. For example, the epoxy-containing molecule may be mixed with a thermally conductive filler, an expandable filler, a reactive diluent comprising an epoxy-functional group, and/or an additive to form the first component. A thiol-containing molecule may be mixed with a thermally conductive filler, an expandable filler, a reactive diluent comprising a thiol-functional group, and/or an additive to form the second component. The first component and the second component and optionally a third component may be mixed to form one of the compositions disclosed above. Such mixing may be at a temperature of less than 50 °C, such as from 0 °C to 50 °C, such as from 15 °C to 35 °C, such as at ambient temperature.

The composition described above may be applied alone or as part of a system that can be deposited in a number of different ways onto a number of different substrates.

Accordingly, disclosed herein are methods for treating a substrate comprising, or consisting essentially of, or consisting of, contacting at least a portion of a surface of the substrate with one of the compositions described hereinabove. That is, the composition can be applied to the surface of a substrate in any number of different ways, non-limiting examples of which include brushes, rollers, films, pellets, trowels, spatulas, dips, spray guns and applicator guns to form a coating on at least a portion of the substrate surface.

After application to the substrate(s), the composition may be cured. For example, the composition may be allowed to cure at room temperature or slightly thermal conditions, and for any desired time period (e.g., from 5 minutes to 1 hour) sufficient to at least partially cure the composition on the substrate(s), provided that the that the thermal conditions may be lower than the expansion onset temperature of the thermally expandable material. The composition may be cured to form a coating on the substrate surface under ambient conditions or slightly thermal conditions. The coating may form a sealant, an adhesive, a gap filler, a pottant or an encapsulant, such as a solid or gel a pad, such as a pad formed in-situ or a discrete pre-manufactured or pre-formed pad, or combinations thereof.

The system may comprise a number of the same or different films, coatings, or layers. A film, coating, or layer is typically formed when a composition that is deposited onto a portion of the substrate surface is cured by methods known to those of ordinary skill in the art (e.g., under ambient conditions).

Also disclosed are methods for forming a bond between two substrates for a wide variety of potential applications in which the bond between the substrates provides particular mechanical properties related to lap shear strength. The method may comprise, or consist essentially of, or consist of, applying the composition described above to a first substrate; contacting a second substrate to the composition such that the composition is located between the first substrate and the second substrate; and curing the composition under ambient conditions or slightly thermal conditions. For example, the composition may be applied to either one or both of the substrate materials being bonded to form an adhesive bond there between and the substrates may be aligned and pressure and/or spacers may be added to control bond thickness. The composition may be applied to cleaned or uncleaned (i.e., including oily or oiled) substrate surfaces. The composition also may be applied to a substrate that has been pretreated, coated with an electrodepositable coating, coated with additional layers such as a primer, basecoat, or topcoat.

The coating composition may dry or cure at ambient conditions once applied to a substrate or substrates coated with coating compositions may optionally subsequently be baked in an oven to cure the coating composition, as described in more detail below.

After application to the substrate(s), the composition may be cured. For example, the composition may be allowed to cure at ambient conditions or slightly thermal conditions. Additionally, the composition also may be further cured by baking at elevated temperature, such as at a temperature of less than 90 °C, such as less than 80 °C, such as less than 70 °C, such as less than 60 °C, but greater than ambient, such as greater than 40 °C, such as greater than 50 °C, and for any desired time period (e.g., from 5 minutes to 1 hour) sufficient to at least partially cure the composition on the substrate(s), provided that the thermal conditions may be lower than the expansion onset temperature of the thermally expandable material.

The coatings disclosed herein may be cohesive or non-cohesive.

The coatings disclosed herein may have a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K.

Post-expansion, the coatings disclosed herein may have a decrease in thermal conductivity of at least 10%, such as at least 25%, such as at least 50%, such as at least 75%, such as at least 95%, such as at least 96%, such as at least 97%, such as at least 98%, such as at least 99%, compared to the pre-expansion thermal conductivity of the coating.

The cohesive coatings disclosed herein may have an expansion volume ratio of greater than 1, such as at least 1.1, such as at least 1.2, such as at least 1.5, such as at least 2, such as at least 3, such as at least 5, such as at least 10, such as at least 20. Coatings may be exposed to at least the expansion onset temperature of the thermally expandable materials up to 230 °C, such as up to 220 °C, such as up to 210 °C, such as up to 200 °C, such as up to 190 °C, such as up to 180 °C, such as up to 170 °C.

The compositions disclosed herein are highly loaded compositions (i.e., contained thermally conductive filler in an amount up to 90 percent by weight) and are pumpable (i.e., each component having a viscosity of no more than 10⁶ Pa·s at a shear stress of 1 Hz measured by an Anton Paar MCR 301 rotational rheometer at 25 °C using a parallel plate with a diameter of 25 mm (1 mm gap). This was a surprising result.

The coatings disclosed herein may have a pre-expansion tensile stress of at least 0.5 MPa measured according to ISO-37 TYPE 2 at a pull rate of 10 mm per minute, such as at least 0.6 MPa, such as at least 0.7 MPa. These results were surprising for such a highly loaded system.

The coatings disclosed herein may have a pre-expansion tensile strain of at least 5% measured according to ISO-37 TYPE 2 at a pull rate of 10 mm per minute, such as at least 6%. These results were surprising for such a highly loaded system.

The combination of properties described above was surprising and unexpected.

The composition may be injected or otherwise placed in a die caster or a mould and at least partially dried or cured under ambient conditions or by exposure to an external energy source, for example such as by heating to a temperature of less than 180 °C, such as less than 130 °C, such as less than 90 °C to form a part or a member and optionally may be machined to a particular configuration.

### Dielectric Coating Systems and Kits

Also disclosed herein are dielectric coating systems. The dielectric coating system may comprise: a first composition for application to a first portion of a substrate surface, the first composition comprising a dielectric coating composition; and a second composition for application to a second portion of a substrate surface, the second composition comprising any of the thermally conductive, thermally expandable compositions disclosed hereinabove. The first portion and the second portion may be on a single substrate or may be on a first substrate and a second substrate, respectively.

Also disclosed herein are dielectric coating kits. The dielectric coating kit may comprise: a first composition for application to a first portion of a substrate surface, the first composition comprising a dielectric coating composition; and a second composition for application to a second portion of a substrate surface, the second composition comprising any of the thermally conductive, thermally expandable compositions disclosed hereinabove. The first portion and the second portion may be on a single substrate or may be on a first substrate and a second substrate, respectively. The kit optionally may comprise instructions for applying the first composition and the second composition to the first portion and the second portion of the substrate surface, respectively.

When used with respect to the dielectric coating systems and kits disclosed herein, the first portion and the second portion may be the same or different, provided that the first portion and the second portion overlap to form a coating stack, e.g., a thermally conductive, thermally expandable coating on a dielectric coating. Such a coating stack does not preclude the possibility of coatings in addition to the dielectric coating and the thermally conductive, thermally expandable coating, wherein such additional coatings may or may not be between the dielectric coating and the thermally conductive, thermally expandable coating. Optionally, the coating stack may be formed between two substrates.

The dielectric coating may be formed on a first portion of a surface of a first substrate and the thermally conductive, thermally expandable coating may be formed on a second portion of a surface of a second substrate and the substrates may be positioned such that the first portions and the second portions overlap to form a coating stack as described above.

As used herein, “dielectric” refers to a coating composition or coating comprising a dielectric strength of at least 10 kV/mm measured using a Sefelec Dielectric Strength Tester (RMG12AC-DC; voltage limit 12.0 kV, Imax Limit 0.1 mA, 19 sec ramp, 20 sec dwell, 2 sec fall) according to ASTM D149-09, such as at least 12 kV/mm, such as at least 15 kV/mm.

The dielectric coating composition may comprise a binder comprising a film-forming resin. As used herein, “film-forming resin” refers to one or more monomers, oligomers, prepolymers and/or polymers, such as homopolymers and/or copolymers, that are capable of forming a coating upon reaction with a curing agent or crosslinker, upon evaporation of a solvent, and/or upon photo or thermal activation. The dielectric coating composition may comprise any suitable film-forming resin, including organic film-forming resins and/or inorganic film-forming resins, such as silicon-based film-forming resins. Examples of suitable film-forming resins include but are not limited to polyester, alkyd, urethane, isocyanate, polyurea, epoxy, acrylic, polyether, polysulfide, polyamine, polyamide, polyvinyl chloride, polyolefin, polyvinylidene fluoride, polyvinyl chloride, polyolefin, polysiloxane, amine-aldehydes, resinous polyols, phosphatized polyepoxides, phosphatized acrylic polymers, aminoplasts, or combinations thereof.

The dielectric coating composition may optionally comprise a curing agent and/or crosslinker that is capable of crosslinking with the film-forming resin to cure the dielectric coating composition. Any suitable curing agent and/or crosslinker that is capable of crosslinking with the film-forming resin may be used. Examples of suitable curing agents include but are not limited to amines, aminoplasts, phenoplasts, polyisocyanates, including blocked isocyanates, polyepoxides, beta-hydroxyalkylamides, polyacids, organometallic acid-functional materials, polyamines, polyamides, polysulfides, polythiols, polyenes such as polyacrylates, polyols, polysilanes and the like, or combinations thereof.

The dielectric coating composition may optionally further comprise colorants, pigments, additives, and/or fillers. Suitable fillers that may be used in the dielectric coating composition include thermally conductive, electrically insulative filler materials, thermally conductive, electrically conductive filler materials, and/or thermally insulative, electrically insulative filler materials.

The dielectric coating composition may comprise a thermoset coating composition, wherein the coating composition is cured upon crosslinking of a film-forming resin and a curing agent and/or crosslinker. Alternatively, the dielectric coating composition may comprise a thermoplastic coating composition, wherein the coating composition comprises a film-forming resin that cures upon evaporation of water and/or solvent. Alternatively, the dielectric coating composition may comprise a thermoset or thermoplastic coating composition that cures upon exposure to actinic radiation, such as ultraviolet light.

The dielectric coating composition may comprise a liquid coating composition or a powder coating composition. As used herein, when referring to a dielectric coating composition, “liquid” means a material having a viscosity less than 100,000 Pas at 25 °C as measured by parallel plate rheology with a plate diameter of 25 mm, a gap of 0.5 mm, and a shear rate of 1 s⁻¹.

Suitable liquid coating compositions include but are not limited to electrodepositable coating compositions, one-component coating compositions, and/or multi-component coating compositions.

For example, the liquid dielectric coating composition may comprise an electrodepositable coating composition. The electrodepositable coating composition may comprise one or more cationic or anionic salt group-containing film-forming resins that may be deposited onto a metal or other conductive substrate under the influence of an applied electrical potential, i.e., by electrodeposition.

In other examples, the liquid dielectric coating composition may comprise a UV-curable coating composition comprising film-forming resins capable of curing upon exposure to UV radiation. Any suitable UV-curable film-forming resin may be used, such as free radical polymerizable resins containing ethylenic unsaturation or olefinic double bonds and/or film-forming resins that may react through a cationic photopolymerization mechanism. Examples of suitable UV-curable coating compositions that may be used include but are not limited to the RAYCRON line of UV-curable coatings, commercially available from PPG Industries, Inc.

Other suitable liquid dielectric coating compositions include but are not limited to the SPECTRACRON line of solvent-based coating compositions and the AQUACRON line of water-based coating compositions, all commercially available from PPG Industries, Inc. The liquid dielectric coating may also be applied as a two-component composition where the film-forming resins and the reactive curing agent and/or crosslinker are mixed just before application of the coating composition and may optionally cure under ambient conditions without any external energy source.

Alternatively, the dielectric coating composition may comprise a powder coating composition. “Powder coating composition” as used herein refers to any dielectric coating composition in the form of a co-reactable solid in particulate form which may be substantially free, essentially free, or completely free of water and/or solvent. Suitable film-forming resins useful in dielectric powder coating compositions include those discussed in PCT Publ. No. WO 2021/173941A1, pars. [0006] to [0042], [0057] to [0068], [0088] to [0105] and [0128] to [0139], incorporated herein by reference. Non-limiting examples of suitable powder compositions that may be used in the present disclosure include the polyester-based ENVIROCRON line of powder coating compositions (commercially available from PPG Industries, Inc.), silicon modified polyester compositions, epoxy-polyester hybrid compositions, and/or UV-curable powder compositions.

The dielectric coating composition may be applied to a substrate by any suitable method known in the art, including but not limited to electrodeposition, coil coating, spraying, such as electrostatic spraying, flow coating, spin coating, curtain coating, brushing, dipping, hot-melt extrusion, application of a free-standing film, and/or by the use of a fluidized bed. Once applied to the substrate, the dielectric coating composition may be cured by any method known in the art, such as baking, induction heating, infrared heating, and/or exposure to actinic radiation such as UV.

A dielectric coating may be formed from the dielectric coating compositions described herein.

The dielectric coating may comprise a dielectric strength of at least 10 kV/mm measured using a Sefelec Dielectric Strength Tester (RMG12AC-DC; voltage limit 12.0 kV DC, Imax Limit 0.1 mA, 19 sec ramp, 20 sec dwell, 2 sec fall) according to ASTM D149-09, such as at least 12 kV/mm, such as at least 15 kV/mm. The dielectric coating may comprise a dielectric strength of no more than 120 kV/mm measured using a Sefelec Dielectric Strength Tester (RMG12AC-DC; voltage limit 12.0 kV DC, Imax Limit 0.1 mA, 19 sec ramp, 20 sec dwell, 2 sec fall) according to ASTM D149-09, such as no more than 100 kV/mm. The dielectric coating may comprise a dielectric strength of 10 kV/mm to 120 kV/mm measured using a Sefelec Dielectric Strength Tester (RMG12AC-DC; voltage limit 12.0 kV DC, Imax Limit 0.1 mA, 19 sec ramp, 20 sec dwell, 2 sec fall) according to ASTM D149-09, such as 12 kV/mm to 100 kV/mm, such as 15 kV/mm to 100 kV/mm.

The dielectric coating may be formulated as a hot-melt or a free-standing film. As used herein, a “free-standing film” refers to a sheet comprising a cured composition that may be formed independent of a substrate surface. The free-standing film may optionally comprise an adhesive layer, such as a pressure sensitive adhesive layer.

### 3-D Printing

Compositions of the present disclosure may be applied or deposited using any suitable method, including those aforementioned. Alternatively, the composition may be casted, extruded, molded, or machined to form a part or a member in at least partially dried or cured state.

The compositions disclosed herein may be used in any suitable additive manufacturing technology, such as three-dimensional (3D) printing, extrusion, jetting, and binder jetting. Additive manufacturing refers to a process of producing a part or member by constructing it in layers, such as one layer at a time.

The present disclosure is also directed to the production of structural articles, such as by way of a non-limiting example, sound damping pads, using an additive manufacturing process, such as 3D printing. 3D printing refers to a computerized process, optionally including artificial intelligence modulation, by which materials are printed or deposited in successive layers to produce a 3D part or member, such as, by way of a non-limiting example, sound damping pads in a battery assembly. A 3D part or member may be produced by depositing successive portions or layers over a base of any spatial configuration and thereafter depositing additional portions or layers over the underlying deposited portion or layer and/or adjacent to the previously deposited portion or layer to produce the 3D printed part or member.

It will be appreciated that the configuration of the 3D printing process, including the selection of suitable deposition equipment, depends on a number of factors such as the deposition volume, the viscosity of the composition and the complexity of the part being fabricated. Any suitable mixing, delivery, and 3D printing equipment as known to those skilled in the art, may be used. Compositions may be printed or deposited in any size and/or shape of droplets or extrudate, and in any patterns to produce the 3D structure.

Compositions as disclosed herein may be applied or deposited by any suitable 3D printing method as known to those skilled in the art. First and second components of 2K compositions may be mixed and then deposited, or the first and second components may be deposited separately, such as simultaneously and/or sequentially.

First and second components may be premixed, i.e., mixed together, prior to application, and then deposited. The mixture may be at least partially reacted or thermoset when the material is deposited; the deposited reaction mixture may react at least in part after deposition and may also react with previously deposited portions and/or subsequently deposited portions of the article such as underlying layers or overlying layers of the article.

In a non-limiting example, the first and two components may be released from their individual storage containers and pushed, such as pumped through conduits, such as hoses, to a mixer, such as a static or dynamic mixer, wherein the composition may be mixed for a time sufficient to homogenize the composition, wherein the composition may then be released through an outlet. The outlet may be a deposition device, such as a printing head, and/or the materials may exit the mixing unit and be pushed, such as by a pump, through a conduit, such as a hose, to the printing head. The printing head may optionally be mounted on a 3D rotational robotic arm to allow delivery of 3D print compositions to any base in any spatial configuration and/or the base may be manipulated in any spatial configuration during the 3D printing process.

Alternatively, first and second components may be deposited independently from different printing heads. The first component may be deposited from one printing head and the second component may be deposited from a second printing head. The first and second components may be deposited in any pattern such that the first and second components comprising any deposited layer can react together as well as react with underlying and/or overlying layers to produce the 3D printed part or member.

Methods provided by the present disclosure include printing the composition on a fabricated part. Methods provided by the present disclosure include directly printing parts.

Using the methods provided by the present disclosure parts can be fabricated. The entire part can be formed from one of the compositions disclosed herein, one or more portions of a part can be formed from one of the compositions disclosed herein, one or more different portions of a part can be formed using the compositions disclosed herein, and/or one or more surfaces of a part can be formed from a composition provided by the present disclosure. In addition, internal regions of a part can be formed from a composition provided by the present disclosure.

### Uses of the Compositions and Coatings

The compositions disclosed herein may be used to form a cohesive coating when the coating is exposed to at least the expansion onset temperature of the thermally expandable material.

The compositions disclosed herein may be used to form a non-cohesive coating when the coating is exposed to at least the expansion onset temperature of the thermally expandable material, which can be useful for removal of the coating from a substrate surface, such as removability of a battery cell from a battery pack.

The compositions disclosed herein may be used to prevent, delay or mitigate thermal runaway. As used herein, the term “thermal runaway” means a cyclic, self-propagating process wherein a cascade of exothermic reactions generate thermal energy faster than the thermal energy can be dissipated, resulting in a rapid and uncontrollable increase in temperature.

The compositions disclosed herein may be formulated into highly loaded compositions (i.e., compositions comprising thermally conductive filler in an amount up to 90 percent by weight) that are pumpable (i.e., each component having a viscosity of no more than 10⁶ Pa·s at a shear stress of 1 Hz measured by an Anton Paar MCR 301 rotational rheometer at 25 °C using a parallel plate with a diameter of 25 mm (1 mm gap).

These highly loaded compositions may be used to form coatings that are capable of an increase in volume of up to 550%, such as up to 600%, such as up to 700%, upon exposure to thermal conditions while remaining cohesive.

The compositions disclosed herein may be used to form coatings, such as cohesive coatings, having the following properties:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

The combination of properties described above was surprising and unexpected.

The compositions disclosed herein may be used to form coatings, such as non-cohesive coatings, having the following properties:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

The combination of properties described above was surprising and unexpected.

### Substrates

Compositions described herein may be coated or deposited on, or otherwise contacted with, any substrate or surface, such as, but not limited to metals or metal alloys, polymeric materials, such as plastics including filled and unfilled thermoplastic or thermoset materials, and/or composite materials. Other suitable substrates include, but are not limited to, glass or natural materials such as wood. Substrates may include two or more of any different materials in any combination, such as, but not limited to, two different metals, or a metal and a metal alloy, or a metal and a metal alloy and one or more composite materials.

Suitable substrates may include, but are not limited to, both flexible and rigid metal substrates such as ferrous metals, aluminum, aluminum alloys, magnesium, titanium, copper, and other metal and alloy substrates. The ferrous metal substrates may include, for example, iron, steel, and alloys thereof. Non-limiting examples of useful steel materials include cold rolled steel, nickel plated cold rolled steel, galvanized (zinc coated) steel, electrogalvanized steel, stainless steel, pickled steel, zinc-iron alloy such as GALVANNEAL, and combinations thereof. Aluminum alloys, such as those, for example, of the 1XXX, 2XXX, 3XXX, 4XXX, 5XXX, 6XXX, 7XXX, or 8XXX series as well as clad aluminum alloys and cast aluminum alloys, such as those, for example, of the A356, 1XX.X, 2XX.X, 3XX.X, 4XX.X, 5XX.X, 6XX.X, 7XX.X, or 8XX.X series also may be used as the substrate. The substrate also may comprise, for example, magnesium, such as magnesium alloys of the AZ31B, AZ91C, AM60B, or EV31A series, titanium and/or titanium alloys, such as those of grades 1-36 including H grade variants, copper and copper alloys, or other non-ferrous metals, as well as alloys of these materials. The substrate may comprise a composite material such as a plastic, fiberglass and/or carbon fiber composite.

It will also be understood that the substrate may comprise a bare substrate or the substrate may be pretreated or pre-coated, at least in part, with one or more layers. Suitable pretreatment solutions may include but are not limited to a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The substrate may be in any form, such as, without limitation, a sheet, a foil, a laminate foil, a pad, a fabricated part, a component, or an article. Compositions comprising the materials disclosed herein may be used to coat a substrate, such as by depositing, applying or contacting the compositions to a substrate surface. The compositions, in an at least partially cured state, may be used in any form, such as but not limited to, a coating, a sealant, an adhesive, a pottant or an encapsulant, such as a solid or gel, a pad, such as a pad formed in-situ or a discrete pre-manufactured or pre-formed pad.

In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2).

The compositions disclosed herein are not limited and may be particularly suitable for use in various transportation applications including automotive applications, commercial transport applications, rail locomotive, marine applications and/or aerospace applications. Suitable substrates for use in the present disclosure include those that are used in the assembly of vehicular bodies (for example, without limitation, door, body panel, trunk deck lid, roof panel, hood, roof and/or stringers, rivets, landing gear components, and/or skins used on an aircraft), vehicular frames, vehicular parts, motorcycles, wheels, and industrial structures and components. As used herein, “vehicle” or variations thereof includes, but is not limited to, civilian vehicles, light and heavy commercial vehicles, civilian and military aircraft, and/or land vehicles such as cars, motorcycles, and/or trucks. The compositions disclosed herein also may be suitable for use in various industrial applications including appliances, personal electronic devices, circuit boards, and the like, or combinations thereof.

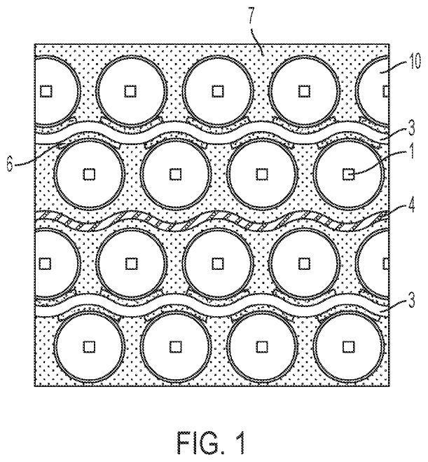

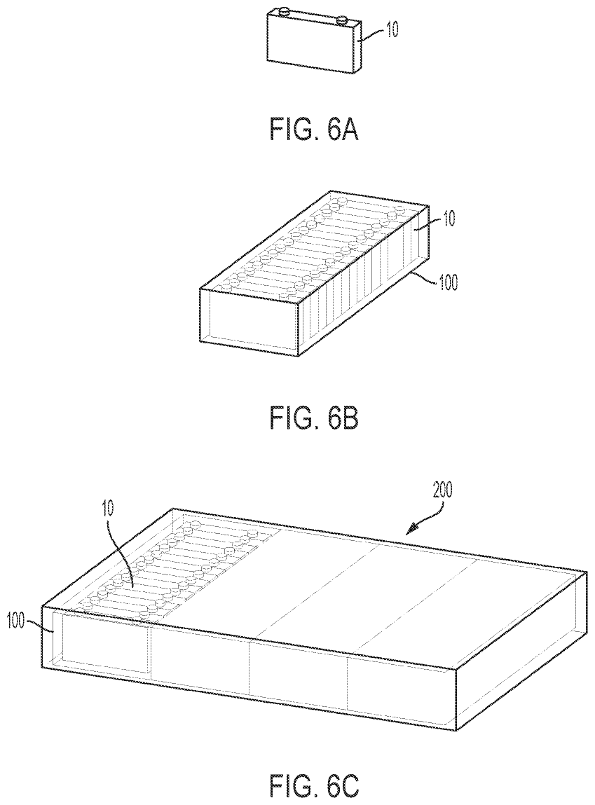

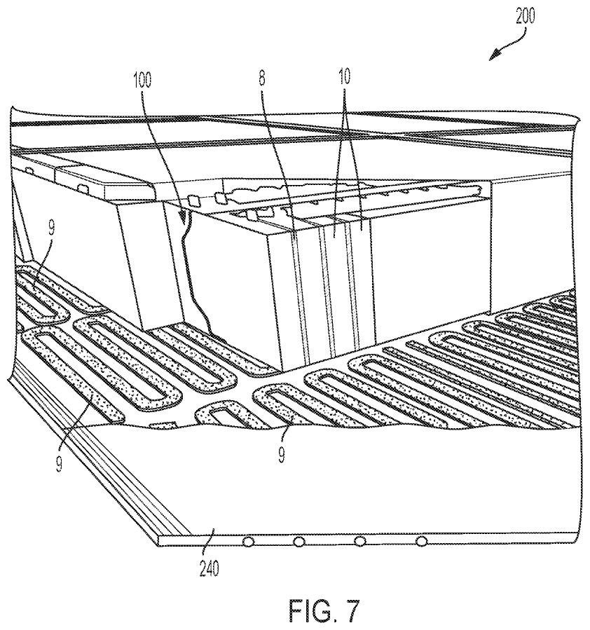

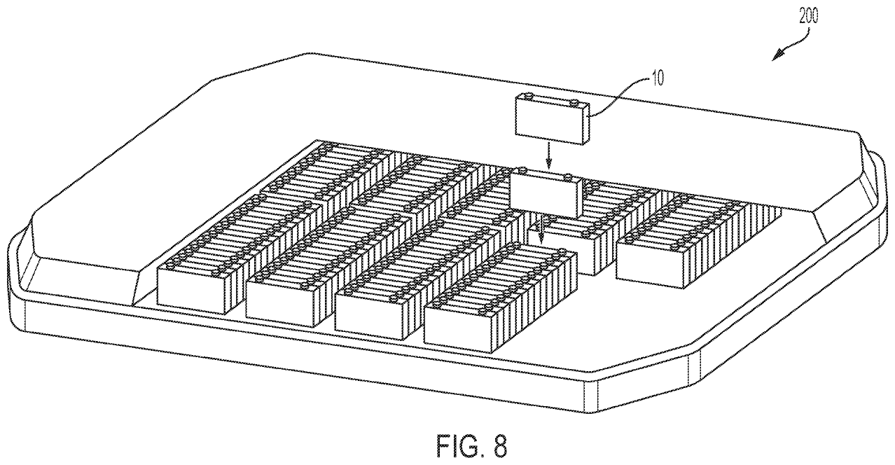

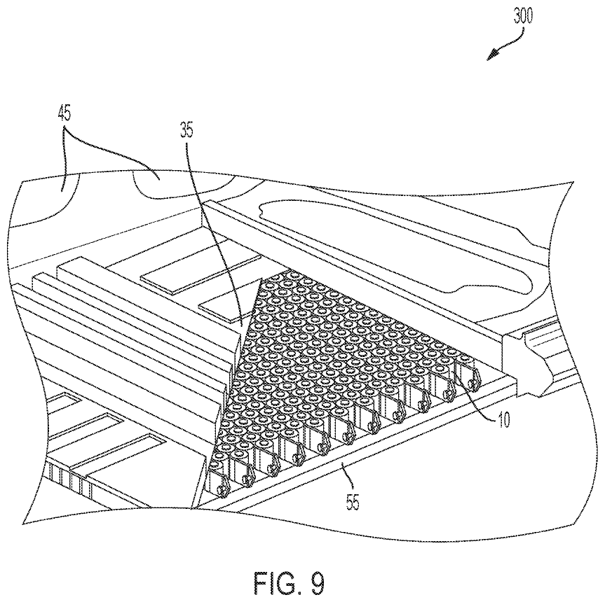

FIGS. 1 to 9 illustrate non-limiting examples of battery assembly components and constructions as well as non-limiting applications or use of compositions as disclosed herein in said battery assemblies. Although FIGS. 1 to 9 illustrate specific examples of cell shapes and cell arrangements, cells may be arranged in any configuration known to those skilled in the art. Additionally, the compositions disclosed herein, in an at least partially cured state, may be used to form pads, adhesives, coatings, pottants and the like, to provide thermal protection between battery cells, within battery modules and/or within battery packs. These materials may be used on any surface or in any space within such battery assemblies. For example, compositions disclosed herein also may be useful in battery assemblies including, but not limited to, cell to module (FIGS. 3, 4, 6B), module to pack (FIGS. 6C, 7), cell to pack (FIG. 8), and cell to chassis battery assemblies (FIG. 9). Such battery assemblies may be used in, but not limited to, any aforementioned application.

Battery assemblies may be any combination of one or more battery cells, the interconnects which provide electrical conductivity between them, as well as ancillary components such as, in non-limiting examples, control electronics and components that ensure the necessary structural mechanical and environmental requirements for the operation of a specific battery (for example, without limitation, cell interconnectors such as wires, battery pack enclosures including trays and lids, module enclosures, module frames and frame plates, module racking, cooling and heating components including cooling plates, cooling fins, and cooling tubes, electrical busbars, battery management systems, battery thermal management systems, chargers, inverters and converters).

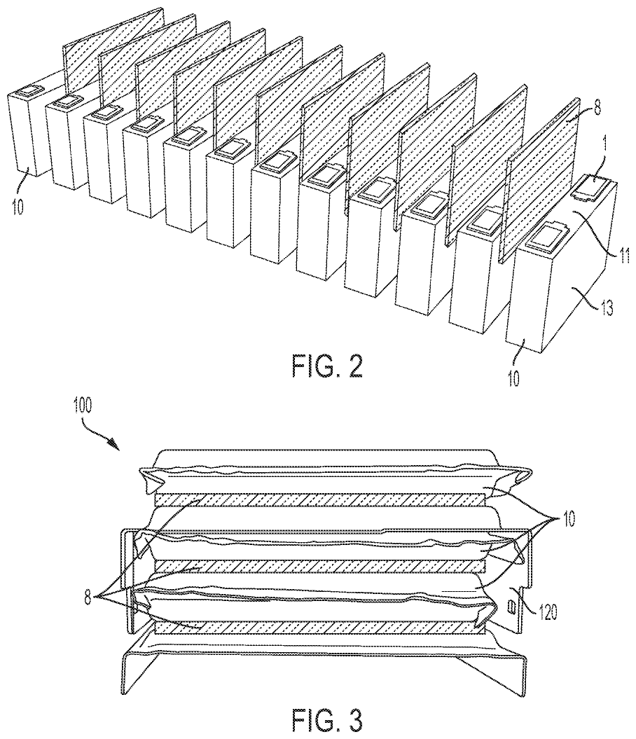

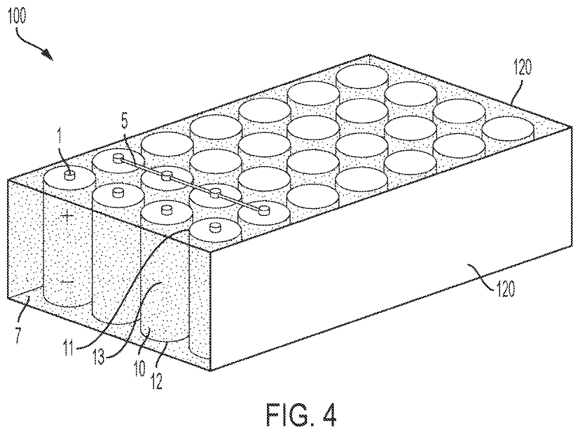

Battery cells 10 are generally single unit energy storage containers that may be connected in series or in parallel. Battery cells may be any suitable size or shape known to those skilled in the art, such as but not limited to, cylindrical (FIGS. 1, 4 and 9), prismatic (FIGS. 2, 5-8) and/or pouch (FIG. 3). Battery cells 10 are enclosed to provide desired mechanical protection and environmental isolation of the cell. For example, cylindrical and prismatic cells may be encased in metal cans, cases, and lids, while pouch cells may be enclosed in multilayer laminate foils. Battery terminals 1 connect the electrodes inside the battery cell to the electrical circuit outside the battery cell, with one being a positive terminal and the other being a negative terminal. As illustrated in FIG. 4, battery cells 10 may be connected by interconnector wires 5 with other battery cells 10 in series or in parallel to enable an electric current to flow between cells 10.

As illustrated in FIGS. 3, 4, 5, 6B, 6C, and 7, battery cells 10 may be arranged in modules 100 comprising multiple cells 10 connected in series or in parallel. The modules 100 may include an at least partial enclosure of the arranged cells 10. Ancillary components, such as those aforementioned, may be included. Spaces of any dimensions may be located between the plurality of cells, ancillary components, base, and/or any interior surface of the module wall or other enclosure 120.

FIG. 1 illustrates a top-down view of cylindrical battery cells 10 having terminals 1. As shown, the cells are arranged in rows with either cooling tubes 3 or dielectric and thermal insulation paper (insulation paper) 4 between them. As shown, materials, such as adhesive 6 and/or pottants 7 optionally formed from the compositions disclosed herein in an at least partially cured state, may be positioned between the cells 10, cooling tubes 3 and/or insulation paper 4.

FIG. 2 illustrates an exploded isometric view of an array of prismatic battery cells 10. As shown, each prismatic cell 10 may comprise a top 11, a bottom, and walls 13 positioned between the top and bottom and each having a surface. As shown, materials, such as pads 8 formed from the compositions disclosed herein in an at least partially cured state, may be positioned between surfaces of cell walls 13 of adjacent cells 10.

FIG. 3 illustrates a cut-out front view of an array of pouch battery cells 10 in a module 100. The module walls 120 at least partially encase the cells 10. As shown, materials, such as pads 8 formed from the compositions disclosed herein in an at least partially cured state, may be positioned between surfaces of cells 10.

FIG. 4 illustrates an isometric view of cylindrical cells 10 in a battery module 100. Each cell may comprise a top 11, a bottom 12, and walls 13 positioned between the top and bottom and each having a surface. The top 11 and the bottom 12 may be oppositely charged terminals with one being a positive terminal 1 and the other being a negative terminal (not shown). The battery cells may be connected at their terminals by interconnectors such as wires 5 and the like to enable an electric current to flow between the electric cells. The module 100 or module walls 120 may form a space having a volume. The cells 10 may be positioned within the space to consume a portion of the volume. The material, such as a pottant 7 formed from the compositions disclosed herein in an at least partially cured state, may be positioned, formed from the coating compositions disclosed herein may be positioned within the space to consume at least a portion of the volume such that the material is adjacent to a surface of a cell wall 13 and/or an interior surface of at least one of the walls 120 of the module 100.

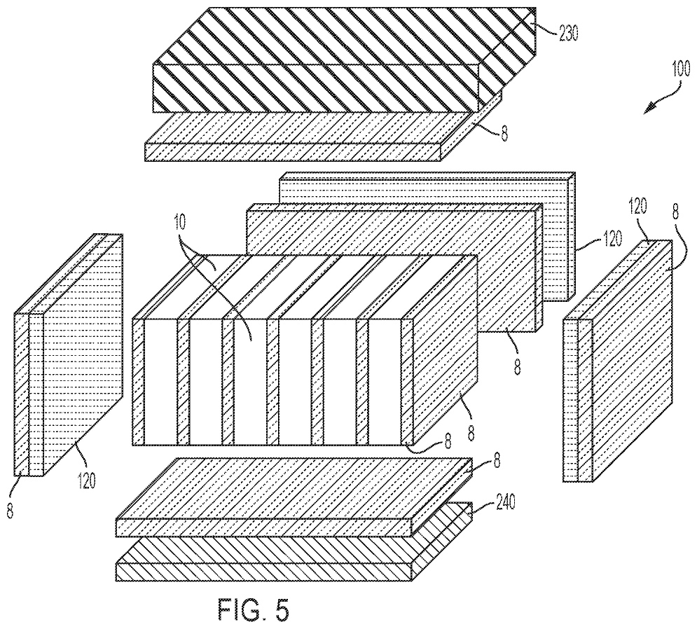

FIG. 5 illustrates an exploded perspective view of a battery module 100 comprised of one or more arrays of battery cells 10, a cooling fin 230, and/or a cooling plate 240. Materials, such as pads 8 formed from the compositions disclosed herein in an at least partially cured state, may be positioned between cells 10. Additional pads 8, may be positioned between the cells 10, the cooling fin 230 and/or the cooling plate 240. Additional materials such as pads 8, or optionally, such as adhesive and/or pottants, formed from the compositions disclosed herein, in an at least partially cured state, may be positioned between the battery cell array and an interior surface of walls 120. Other pads 8 may be positioned adjacent to an exterior surface of the walls 120.

FIG. 6 illustrates an isometric view of a battery cell 10 (FIG. 6A) to battery module 100 (FIG. 6B) to battery pack 200 (FIG. 6C) battery assembly. The battery module 100 comprises a plurality of battery cells 10 and the battery pack 200 comprises a plurality of battery modules 100.

FIG. 7 illustrates a perspective view of a battery pack 200 cutout. The battery pack includes a plurality of battery modules 100 and cells 10 within each module 100. The base of the battery pack 200 comprises a cooling plate 240. Materials, such as adhesives, 9 formed from the compositions disclosed herein in an at least partially cured state, may be positioned between the cooling plate 240 and interior surface of a wall of the battery pack 200. Materials, such as pads 8 formed from the compositions disclosed herein in an at least partially cured state, may be positioned between cells 10 within modules 100.

FIG. 8 illustrates an isometric view of a cell 10 to pack battery 200 assembly. Cells 10 are arranged within the pack 200 (without being in separate modules).

In other cases, the battery cells may be arranged on or within an article such as, but not limited to, a cell to chassis battery assembly, as illustrated in FIG. 9, wherein one or more cells is used to construct the battery assembly without prior assembly of the cells into modules and/or packs. FIG. 9 illustrates an isometric cut-out view of a cell to chassis battery assembly 300. Cells 10 are arranged on a base comprising the undercarriage 55 and supported by the vehicle frame 45 and under the vehicle interior floor 35.

Any battery assembly may further comprise a thermal management system (not shown) comprising air or fluid circuits which may be liquid based (for example glycol solutions) or direct refrigerant based. The fire-retardant material may be adjacent to any of these components of the battery assembly.

In view of the foregoing description the present disclosure thus relates in particular to the following Aspects 1-57 without being limited thereto.

### ASPECTS

Aspect 1. A composition, comprising:
a first component comprising a first molecule comprising an epoxy functional group;
a second component comprising a second molecule comprising a thiol functional group;
a thermally expandable material; and
a thermally conductive filler;
wherein the epoxy functional group and the thiol functional group are reactive under ambient conditions.

Aspect 2. The composition of aspect 1, wherein the composition is substantially free, or essentially free, or completely free, of a latent accelerator.

Aspect 3. The composition of aspect 1 or aspect 2, wherein the first component and/or the second component comprises a viscosity of no more than 10⁶ Pa·s at a shear stress of 1 Hz measured by an Anton Paar MCR 301 rotational rheometer at 25 °C using a parallel plate with a diameter of 25 mm (1 mm gap), such as no more than 105 Pa·s, such as no more than 10+Pa·s, such as no more than 5,000 Pa·s, such as no more than 4,000 Pa·s, such as no more than 3,000 Pa·s, such as no more than 2,000 Pa·s, such as no more than 1,500 Pa·s, such as more than 100 Pa·s, such as more than 200 Pa·s, such as more than 500 Pa·s, such as 100 to 10⁶ Pa·s, such as 100 to 105 Pa·s, such as 100 to 104 Pa·s, such as 100 to 5,000 Pa·s, such as 100 to 4,000 Pa·s, such as 100 to 3,000 Pa·s, such as 100 to 2,000 Pa·s, such as 100 to 1,500 Pa·s, such as 200 to 10⁶ Pa·s, such as 200 to 105 Pa·s, such as 200 to 104 Pa·s, such as 200 to 5,000 Pa·s, such as 200 to 4,000 Pa·s, such as 200 to 3,000 Pa·s, such as 200 to 2,000 Pa·s, such as 200 to 1,500 Pa·s, such as 500 to 10⁶ Pa·s, such as 500 to 105 Pa·s, such as 500 to 104 Pa·s, such as 500 to 5,000 Pa·s, such as 500 to 4,000 Pa·s, such as 500 to 3,000 Pa·s, such as 500 to 2,000 Pa·s, such as 500 to 1,500 Pa·s.

Aspect 4. The composition of any of the preceding aspects, wherein the epoxy-containing molecule and/or the thiol-containing molecule comprises a viscosity of at least 1 mPa·s at 298° K and 1 atm according to ASTM D789, such as at least 2 mPa·s, such as no more than 4,000 mPa·s, such as no more than 3,000 mPa·s, such as no more than 2,000 mPa·s, such as no more than 1,000 mPa·s, such as no more than 100 mPa·s, such as no more than 30 mPa·s, such as 1 mPa·s to 4,000 mPa·s, such as for example, from 1 mPa·s to 3,000 mPa·s, 1 mPa·s to 2,000 mPa·s, 1 mPa·s to 1,000 mPa·s, 1 mPa·s to 100 mPa·s, or 2 mPa·s to 30 mPa·s.

Aspect 5. The composition of any of the preceding aspects, wherein:
(a) the first component comprises more than one epoxy-containing molecule; and/or
(b) wherein the epoxy-containing molecules comprise a monoepoxide, a diepoxide, and/or a polyepoxide.

Aspect 6. The composition of any of the preceding aspects, wherein the epoxy-containing molecule comprises an epoxide functionality of at least 2, such as greater than 2, such as at least 2.1, such as at least 2.5, such as at least 3, such as at least 3.5, such as at least 4, such as at least 4.5, such as at least 5, such as at least 5.5, such as at least 6, such as at least 6.5, such as at least 7, such as at least 7.5, such as at least 8, such as at least 8.5, such as at least 9, such as at least 9.5, such as at least 10, such as 2 to 10.

Aspect 7. The composition of any of the preceding aspects, wherein the epoxy-containing molecule comprises a polymer.

Aspect 8. The composition of any of the preceding aspects, wherein the epoxy-containing molecule comprises an epoxy equivalent weight of at least 400 g/eq, such as at least 500 g/eq, such as at least 1,000 g/eq, such as no more than 3,000 g/eq, such as no more than 2,500 g/eq, such as no more than 2,000 g/eq, such as 400 g/eq to 3,000 g/eq, such as 500 g/eq to 2,000 g/eq, such as 1,000 g/eq to 2,000 g/eq.

Aspect 9. The composition of any of aspects 1 to 6, wherein the epoxy-containing molecule comprises a small molecule.

Aspect 10. The composition of aspect 9, wherein the epoxy-containing molecule comprises an epoxy equivalent weight of at least 70 g/eq, such as at least 75 g/eq, such as at least 90 g/eq, such as less than 400 g/eq, such as no more than 350 g/eq, such as no more than 300 g/eq, such as 70 g/eq to less than 400 g/eq, such as 75 g/eq to 350 g/eq, such as 90 g/eq to 300 g/eq.

Aspect 11. The composition of any of the preceding aspects, comprising the epoxy-containing molecule, such as an epoxy-containing polymer and/or an epoxy-containing small molecule, in an amount up to 100 percent by weight based on total weight of the first component, such as at least 0.5 percent by weight, such as at least 1 percent by weight, such as at least 5 percent by weight, such as at least 10 percent by weight, such as at least 20 percent by weight, such as at least 30 percent by weight, such as no more than 90 percent by weight, such as no more than 80 percent by weight, such as no more than 70 percent by weight, such as 0.5 percent by weight to 100 percent by weight, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

Aspect 12. The composition of any of the preceding aspects, wherein the epoxy-containing molecule comprises the at least one functional group in addition to the epoxide functional group(s), such as hydroxide functional groups, silane functional groups, sulfide functional groups, and/or (meth)acrylate functional groups.

Aspect 13. The composition of any of the preceding aspects, wherein:
(a) the second component comprises more than one thiol-containing molecule; and/or
(b) the thiol-containing molecules comprise a monothiol, a dithiol, and/or a polythiol.

Aspect 14. The composition of any of the preceding aspects, wherein the thiol-containing molecule comprises a thiol functionality of at least 2, such as greater than 2, such as at least 2.1, such as at least 2.5, such as at least 3, such as at least 3.5, such as at least 4, such as at least 4.5, such as at least 5, such as at least 5.5, such as at least 6, such as at least 6.5, such as at least 7, such as at least 7.5, such as at least 8, such as at least 8.5, such as at least 9, such as at least 9.5, such as at least 10, such as 2 to 10.

Aspect 15. The composition of any of the preceding aspects, wherein the thiol-containing molecule comprises a polymer.

Aspect 16. The composition of any of the preceding aspects, wherein the thiol-containing molecule comprises a thiol equivalent weight of at least 400 g/eq, such as at least 500 g/eq, such as at least 1,000 g/eq, such as no more than 3,000 g/eq, such as no more than 2,500 g/eq, such as no more than 2,000 g/eq, such as 400 g/eq to 3,000 g/eq, such as 500 g/eq to 2,000 g/eq, such as 1,000 g/eq to 2,000 g/eq.

Aspect 17. The composition of any of aspects 1 to 14, wherein the thiol-containing molecule comprises a small molecule.

Aspect 18. The composition of aspect 17, wherein the thiol-containing molecule comprises a thiol equivalent weight of at least 70 g/eq, such as at least 75 g/eq, such as at least 90 g/eq, such as less than 400 g/eq, such as no more than 350 g/eq, such as no more than 300 g/eq, such as 70 g/eq to less than 400 g/eq, such as 75 g/eq to 350 g/eq, such as 90 g/eq to 300 g/eq.

Aspect 19. The composition of any of the preceding aspects, comprising the thiol-containing molecule, such as a polymeric thiol-containing molecule and/or a small molecule thiol-containing molecule, in an amount up to 100 percent by weight based on total weight of the second component, such as at least 0.5 percent by weight, such as at least 1 percent by weight, such as at least 5 percent by weight, such as at least 10 percent by weight, such as at least 20 percent by weight, such as at least 30 percent by weight, such as no more than 90 percent by weight, such as no more than 80 percent by weight, such as no more than 70 percent by weight, such as 0.5 percent by weight to 100 percent by weight, such as 1 percent by weight to 100 percent by weight, such as 5 percent by weight to 100 percent by weight, such as 10 percent by weight to 100 percent by weight, such as 20 percent by weight to 100 percent by weight, such as 30 percent by weight to 100 percent by weight, such as 0.5 percent by weight to 90 percent by weight, such as 1 percent by weight to 90 percent by weight, such as 5 percent by weight to 90 percent by weight, such as 10 percent by weight to 90 percent by weight, such as 20 percent by weight to 90 percent by weight, such as 30 percent by weight to 90 percent by weight, such as 0.5 percent by weight to 80 percent by weight, such as 1 percent by weight to 80 percent by weight, such as 5 percent by weight to 80 percent by weight, such as 10 percent by weight to 80 percent by weight, such as 20 percent by weight to 80 percent by weight, such as 30 percent by weight to 80 percent by weight, such as 0.5 percent by weight to 70 percent by weight, such as 1 percent by weight to 70 percent by weight, such as 5 percent by weight to 70 percent by weight, such as 10 percent by weight to 70 percent by weight, such as 20 percent by weight to 70 percent by weight, such as 30 percent by weight to 70 percent by weight.

Aspect 20. The composition of any of the preceding aspects, wherein the thiol-containing molecule comprises the at least one functional group in addition to the thiol functional group(s), such as a hydroxide functional group, mercapto functional group, a silane functional group, a phenolic functional group, and/or an amino functional group.

Aspect 21. The composition of any of the preceding aspects, wherein the second molecule is present in an amount such that an equivalence ratio of thiol groups to epoxide groups is at least 1:4, such as at least 1:3, such as at least 1:2, such as no more than 4:1, such as no more than 3:1, such as no more than 2:1, such as 1:4 to 4:1, such as 1:3 to 3:1, such as 1:2 to 2:1.

Aspect 22. The composition of any of the preceding aspects, wherein the thermally expandable material comprises a thermally expandable capsule, such as a hollow thermally expandable capsule.

Aspect 23. The composition of any of the preceding aspects, wherein the thermally expandable material comprises a thermoplastic resin and/or a volatile material such as a hydrocarbon or a gas.

Aspect 24. The composition of any of the preceding aspects, wherein, pre-expansion, the thermally expandable material comprises a D50 particle size of at least at least 1 μm measured by methods known to those skilled in the art, such as laser diffraction or Low Angle Laser Light Scattering (LALLS), such as at least 2 μm, such as at least 3 μm, such as at least 5 μm, such as at least 10 μm, such as no more than 100 μm, such as no more than 80 μm, such as no more than 60 μm, such as no more than 50 μm, such as 0.5 μm to 100 μm, such as 1 μm to 80 μm, such as 2 μm to 60 μm, such as 3 μm to 50 μm, such as 5 μm to 50 μm, such as 10 μm to 50 μm.

Aspect 25. The composition of any of the preceding aspects, wherein:
(a) the thermally expandable material comprises an expansion onset temperature of at least 60 °C, such as at least 70 °C, such as at least 80 °C, such as at least 90 °C, such as at least 100 °C, such as at least 110 °C, such as at least 120 °C, such as at least 130 °C, such as at least 140 °C, such as at least 150 °C, such as at least 160 °C, such as at least 170 °C, such as at least 180 °C, such as at least 190 °C, such as at least 200 °C; and/or
(b) following exposure to at least the expansion onset temperature, the thermally expandable material comprises an expansion volume ratio of at least 1.5 such as at least 2, such as at least 2.5, such as at least 3, such as at least 4, such as at least 5, such as at least 10, such as at least 20, such as at least 50, such as at least 75, such as at least 100, such as at least 125, such as at least 175, such as at least 200.

Aspect 26. The composition of any of the preceding aspects, comprising the thermally expandable material in an amount of at least 0.5 percent by weight based on total weight of the composition, such as at least 0.75 percent by weight, such as at least 1 percent by weight, such as no more than 10 percent by weight, such as no more than 7 percent by weight, such as no more than 3 percent by weight, such as 0.5 percent to 10 percent by weight, such as 0.75 percent to 7 percent by weight, such as 1 percent to 3 percent by weight.

Aspect 27. The composition of any of the preceding aspects, comprising a thermally conductive, electrically insulative filler and/or a thermally conductive, electrically conductive filler.

Aspect 28. The composition of any of the preceding aspects, comprising the thermally conductive filler in an amount of at least 50 percent by weight based on total weight of the composition, such as at least 51 percent by weight, such as at least 52 percent by weight, such as at least 53 percent by weight, such as at least 54 percent by weight, such as at least 55 percent by weight, such as at least 56 percent by weight, such as at least 57 percent by weight, such as at least 58 percent by weight, such as at least 59 percent by weight, such as at least 60 percent by weight, such as at least 61 percent by weight, such as at least 62 percent by weight, such as at least 63 percent by weight, such as at least 64 percent by weight, such as at least 65 percent by weight, such as at least 66 percent by weight, such as at least 67 percent by weight, such as at least 68 percent by weight, such as at least 69 percent by weight, such as at least 70 percent by weight, such as no more than 90 percent by weight, such as no more than 88 percent by weight, 50 percent by weight to 90 percent by weight, such as 51 percent by weight to 90 percent by weight, such as 52 percent by weight to 90 percent by weight, such as 53 percent by weight to 90 percent by weight, such as 54 percent by weight to 90 percent by weight, such as 55 percent by weight to 90 percent by weight, such as 56 percent by weight to 90 percent by weight, such as 57 percent by weight to 90 percent by weight, such as 58 percent by weight to 90 percent by weight, such as 59 percent by weight to 90 percent by weight, such as 60 percent by weight to 90 percent by weight, such as 61 percent by weight to 90 percent by weight, such as 62 percent by weight to 90 percent by weight, such as 63 percent by weight to 90 percent by weight, such as 64 percent by weight to 90 percent by weight, such as 65 percent by weight to 90 percent by weight, such as 66 percent by weight to 90 percent by weight, such as 67 percent by weight to 90 percent by weight, such as 68 percent by weight to 90 percent by weight, such as 69 percent by weight to 90 percent by weight, such as 60 percent by weight to 88 percent by weight, such as 61 percent by weight to 88 percent by weight, such as 62 percent by weight to 88 percent by weight, such as 63 percent by weight to 88 percent by weight, such as 64 percent by weight to 88 percent by weight, such as 65 percent by weight to 88 percent by weight, such as 66 percent by weight to 88 percent by weight, such as 67 percent by weight to 88 percent by weight, such as 68 percent by weight to 88 percent by weight, such as 69 percent by weight to 88 percent by weight, such as 70 percent by weight to 88 percent by weight.

Aspect 29. The composition of any of the preceding aspects, wherein the thermally conductive filler comprises thermally stable filler and/or thermally unstable filler.

Aspect 30. The composition of aspect 29, wherein the composition comprises the thermally stable filler in an amount up to 100 percent by weight of the thermally conductive filler may be thermally stable based on total weight of the thermally conductive filler, such as at least 0.1 percent by weight, such as at least 1 percent by weight, such as at least 10 percent by weight such as at least 15 percent by weight, such as at least 20 percent by weight, such as at least 25 percent by weight, such as at least 30 percent by weight, such as at least 35 percent by weight, such as at least 40 percent by weight, such as at least 45 percent by weight, such as at least 50 percent by weight, such as at least 55 percent by weight, such as at least 60 percent by weight, such as at least 65 percent by weight, such as at least 70 percent by weight, such as least 75 percent by weight, such as at least 80 percent by weight, such as at least 85 percent by weight, such as at least 90 percent by weight, such as at least 91 percent by weight, such as at least 92 percent by weight, such as at least 93 percent by weight, such as at least 94 percent by weight, such as at least 95 percent by weight, such as at least 96 percent by weight, such as at least 97 percent by weight, such as at least 98 percent by weight, such as at least 99 percent by weight, such as 100 percent by weight, such as 0.1 percent by weight to 100 percent by weight, such as 1 percent by weight to 90 percent by weight, such as 10 percent by weight to 80 percent by weight, such as 20 percent by weight to 70 percent by weight, such as 30 percent by weight to 60 percent by weight, such as 90 percent by weight to 100 percent by weight, such as 93 percent by weight to 98 percent by weight.

Aspect 31. The composition of aspect 29 or aspect 30, wherein the composition comprises the thermally unstable filler in an amount up to 100 percent by weight of the thermally conductive filler based on total weight of the thermally conductive filler, such as at least 0.1 percent by weight, such as at least 1 percent by weight, such as at least 10 percent by weight such as at least 15 percent by weight, such as at least 20 percent by weight, such as at least 25 percent by weight, such as at least 30 percent by weight, such as at least 35 percent by weight, such as at least 40 percent by weight, such as at least 45 percent by weight, such as at least 50 percent by weight, such as at least 55 percent by weight, such as at least 60 percent by weight, such as at least 65 percent by weight, such as at least 70 percent by weight, such as least 75 percent by weight, such as at least 80 percent by weight, such as at least 85 percent by weight, such as at least 90 percent by weight, such as at least 91 percent by weight, such as at least 92 percent by weight, such as at least 93 percent by weight, such as at least 94 percent by weight, such as at least 95 percent by weight, such as at least 96 percent by weight, such as at least 97 percent by weight, such as at least 98 percent by weight, such as at least 99 percent by weight, such as 100 percent by weight, such as 0.1 percent by weight to 100 percent by weight, such as 1 percent by weight to 90 percent by weight, such as 10 percent by weight to 80 percent by weight, such as 20 percent by weight to 70 percent by weight, such as 30 percent by weight to 60 percent by weight, such as 90 percent by weight to 100 percent by weight, such as 93 percent by weight to 98 percent by weight, such as no more than 10 percent by weight, such as no more than 9 percent by weight, such as no more than 8 percent by weight, such as no more than 7 percent by weight, such as no more than 6 percent by weight, such as no more than 5 percent by weight, such as no more than 4 percent by weight, such as no more than 3 percent by weight, such as no more than 2 percent by weight, such as no more than 1 percent by weight, such as up to 10 percent by weight, such as 2 percent by weight to 7 percent by weight.

Aspect 32. The composition of any of the preceding aspects, further comprising non-thermally conductive filler, an accelerator, a dispersant, an additive, or combinations thereof.

Aspect 33. The composition of any of the preceding aspects, further comprising a non-thermally conductive, electrically insulative filler.

Aspect 34. The composition of aspect 32 or aspect 33, wherein the composition comprises:
(a) the non-thermally conductive filler in an amount of at least 0.5 percent by weight based on total weight of the composition, such as at least 1 percent by weight, such as at least 1.5 percent by weight, such as no more than 30 percent by weight, such as no more than 20 percent by weight, such as no more than 10 percent by weight, such as up to 30 percent by weight, such as 0.5 percent by weight to 30 percent by weight, such as 1 percent by weight to 20 percent by weight, such as 1.5 percent by weight to 10 percent by weight;
(b) the accelerator in an amount of at least 0.01 percent by weight based on total weight of the composition, such as at least 0.1 percent by weight, such as at least 1 percent by weight, such as no more than 5 percent by weight based on total weight of the composition, such as no more than 4 percent by weight, such as no more than 3 percent by weight, such as 0.01 percent by weight to 5 percent by weight, such as 0.1 percent by weight to 4 percent by weight, such as 1 percent by weight to 3 percent by weight;
(c) the dispersant in an amount of at least 0.5 percent by weight based on total weight of the composition, such as at least 1 percent by weight, such as no more than 10 percent by weight, such as no more than 5 percent by weight, such as more than 0 percent by weight to 10 percent by weight, such as 0.5 percent by weight to 10 percent by weight, such as 1 percent by weight to 5 percent by weight; and/or
(d) the additive in an amount of greater than 0 percent by weight based on total weight of the composition, such as at least 1 percent by weight, such as at least 2 percent by weight, such as at least 5 percent by weight, such as no more than 15 percent by weight, such as no more than 10 percent by weight, such as more than 0 percent by weight to 15 percent by weight, such as 1 percent by weight to 15 percent by weight, such as 2 percent by weight to 10 percent by weight, such as 5 percent by weight to 10 percent by weight.

Aspect 35. The composition of any of the preceding aspects, comprising:
(a) a total solids content of at least 90 percent by weight based on total weight of the composition, such as at least 91 percent by weight, such as at least 92 percent by weight, such as at least 93 percent by weight, such as at least 94 percent by weight, such as at least 95 percent by weight, such as at least 96 percent by weight, such as at least 97 percent by weight, such as at least 98 percent by weight, such as at least 99 percent by weight, such as 100 percent by weight; and/or
(b) the first molecule and the second molecule in a total amount of at least 9.5 percent by weight based on total weight of the composition, such as at least 15 percent by weight, such as no more than 90 percent by weight, such as no more than 80 percent by weight, such as 9.5 percent by weight to 90 percent by weight, such as 15 percent by weight to 80 percent by weight.

Aspect 36. The composition of any of the preceding aspects, wherein the composition is substantially free, or essentially free, or completely free, of solvent.

Aspect 37. A method of coating a substrate comprising: contacting a portion of a surface of the substrate with the composition.

Aspect 38. The method of aspect 37, further comprising mixing the first component and the second component to form the composition of any of the preceding claims; and optionally heating the composition following the contacting.

Aspect 39. The method of aspect 37 or aspect 38, further comprising contacting a surface of a second substrate to the composition such that the composition is between the first and the second substrate.

Aspect 40. A method of forming an article comprising extruding the composition of any of aspects 1 to 36.

Aspect 41. The method of aspect 40, wherein the extruding comprises three-dimensional printing.

Aspect 42. The article formed by the method of aspect 40 or aspect 41.

Aspect 43. A substrate comprising a coating formed from the composition of any of aspects 1 to 36 on a portion of a surface of the substrate.

Aspect 44. The substrate of aspect 43, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

Aspect 45. The substrate of aspect 43 or aspect 44, wherein the coating comprises a cohesive coating.

Aspect 46. The substrate of aspect 43, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

Aspect 47. The substrate of aspect 43 or aspect 46, wherein the coating comprises a non-cohesive coating.

Aspect 48. The substrate of any of aspects 43 to 47, coated according to the method of any of aspects 37 to 39.

Aspect 49. The substrate of any of aspects 43 to 48, wherein the coating comprises a sealant, an adhesive, a gap filler, a pottant, an encapsulant such as a solid or a gel, and/or a pad such as a pre-formed pad, a pre-manufactured pad, a pad formed in situ.

Aspect 50. An article or a part comprising the substrate of any of aspects 43 to 49.

Aspect 51. The article or part of aspect 50, wherein the article or part comprises a vehicle, an appliance, a personal electronic device, a circuit board, a battery cell, a multi-metal substrate, or combinations thereof.

Aspect 52. The article or part of aspect 51, wherein the vehicle comprises a land vehicle or an aircraft.

Aspect 53. A battery comprising a battery cell and a coating formed from the composition of any of aspects 1 to 36.

Aspect 54. The battery of aspect 53, wherein the battery cell and the coating are housed in a module.

Aspect 55. The battery of aspect 53, wherein the battery and the coating are housed in a pack.

Aspect 56. The battery of aspect 54, wherein the module is housed in a pack.

Aspect 57. The battery of aspect 53, adjacent to a vehicle chassis.

Aspect 58. The battery of any of aspects 53 to 57, further comprising a battery component.

Aspect 59. The battery of any of aspects 53 to 58, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

Aspect 60. The substrate of any of aspects 53 to 59, wherein the coating comprises a cohesive coating.

Aspect 61. The substrate of any of aspects 53 to 58, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

Aspect 62. The substrate of any of aspects 53 to 58 or aspect 61, wherein the coating comprises a non-cohesive coating.

Aspect 63. The battery of any of aspects 53 to 62, wherein the coating comprises a sealant, an adhesive, a gap filler, a pottant, an encapsulant such as a solid or a gel, and/or a pad such as a pre-formed pad, a pre-manufactured pad, a pad formed in situ.

Aspect 64. A vehicle comprising the battery of any of aspects 53 to 63.

Aspect 65. The vehicle of aspect 64, wherein the vehicle comprises a land vehicle or an aircraft.

Aspect 66. A use of the composition of any of aspects 1 to 36 for forming a coating useful for preventing thermal runaway.

Aspect 67. The use of aspect 66, wherein the coating comprises a cohesive coating.

Aspect 68. The use of aspect 66, wherein the coating comprises a non-cohesive coating.

Aspect 69. A use of the composition of any of aspects 1 to 36, for making a cohesive coating.

Aspect 70. The use of any of aspects 66, 67 or 69, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

Aspect 71. A use of the composition of any of aspects 1 to 36, for making a non-cohesive coating.

Aspect 72. The use of any of aspects 66, 68, or 71, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

Aspect 73. A system, comprising:
a first composition for application to a first portion of a substrate surface, the first composition comprising a dielectric coating composition; and
a second composition for application to a second portion of a substrate surface, the second composition comprising the composition of any of aspects 1 to 36.

Aspect 74. A kit, comprising:
a first composition for application to a first portion of a substrate surface, the first composition comprising a dielectric coating composition; and
a second composition for application to a second portion of a substrate surface, the second composition comprising the composition of any of aspects 1 to 36.

Aspect 75. The kit of aspect 74, further comprising instructions for applying the first composition and the second composition to the first portion and the second portion, respectively.

Aspect 76. The system or kit of any of aspects 73 to 75, wherein the dielectric coating composition comprises:
a binder comprising a film-forming resin such as a polyester, alkyd, urethane, isocyanate, polyurea, epoxy, acrylic, polyether, polysulfide, polyamine, polyamide, polyvinyl chloride, polyolefin, polyvinylidene fluoride, polyvinyl chloride, polyolefin, polysiloxane, amine-aldehydes, resinous polyols, phosphatized polyepoxides, phosphatized acrylic polymers, aminoplasts, or combinations thereof; and/or
a curing agent and/or crosslinker capable of crosslinking with the film-forming resin to cure the dielectric coating composition, such as an amine, aminoplast, phenoplast, polyisocyanate, including blocked isocyanate, polyepoxide, beta-hydroxyalkylamide, polyacid, organometallic acid-functional material, polyamine, polyamide, polysulfide, polythiol, polyene such as polyacrylate, polyol, polysilane and the like, or combinations thereof.

Aspect 77. The system or kit of any of aspects 73 to 76, wherein the dielectric coating composition comprises a liquid coating composition and/or a powder coating composition.

Aspect 78. The system or kit of any of aspects 73 to 77, wherein the liquid coating compositions comprise an electrodepositable coating composition, a UV-curable coating composition, and/or a solvent-based coating composition.

Aspect 79. A substrate formed from the system or kit of any of aspects 73 to 78, comprising:
a dielectric coating formed from the dielectric coating composition; and
a coating formed from the coating composition.

Aspect 80. The substrate of aspect 79, wherein the dielectric coating comprises a dielectric strength of at least 10 kV/mm measured using a Sefelec Dielectric Strength Tester (RMG12AC-DC; voltage limit 12.0 kV DC, Imax Limit 0.1 mA, 19 sec ramp, 20 sec dwell, 2 sec fall) according to ASTM D149-09, such as at least 12 kV/mm, such as at least 15 kV/mm, such as no more than 120 kV/mm, such as no more than 100 kV/mm, such as 10 kV/mm to 120 kV/mm, such as 12 kV/mm to 100 kV/mm, such as 15 kV/mm to 100 kV/mm.

Aspect 81. The substrate of aspect 79 or aspect 80, wherein the coating comprises a cohesive coating.

Aspect 82. The substrate of any of aspects 79 to 81, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

Aspect 83. The substrate of any of aspects 79 to 81, wherein the coating comprises a non-cohesive coating.

Aspect 84. The substrate of any of aspects 79, 80 or 83, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

The following examples are intended to illustrate the disclosure and should not be construed as limiting the disclosure in any way.

### Example 1: Synthesis of an Epoxy Functional Disulfide

An epoxy functional polyester was prepared using the materials listed in Table 1.

TABLE 1

| Ingredients | Parts by weight |
|---|---|
| Thioplast G4¹ | 220.0 |
| Epon 863² | 142.8 |
| Triethylamine³ | 0.003 |

¹Thioplast G4 is commercially available from Nouryon.
²Epon 863 is commercially available from Hexion Specialty Chemicals.
³Triethylamine is commercially available from Sigma Aldrich.

The ingredients provided in Table 1 were added to a 1000-milliliter, 4-necked round flask equipped with a motor driven stainless steel stir blade, a water-cooled condenser, a nitrogen blanket, and a heating mantle with a thermometer connected through a temperature feedback control device. The contents of the flask were heated to 90 °C until the epoxy equivalent weight (EEW) was over 825 g/eq. In order to measure the epoxy equivalent weight, a sample of 0.06 g per 100 g/eq of the predicted epoxy equivalent weight was dissolved in 20 mL of methylene chloride or tetrahydrofuran. 40 mL of glacial acetic acid and 1 g of tetraethylammonium bromide were added to the sample. The sample was then titrated with 0.1 N perchloric acid in glacial acetic acid using a Metrohm 808 or 888 Titrando. The reaction mixture was then poured out at 40 °C. The final EEW of the epoxy functional polydisulfide was 926 g/eq. The final molecular weight of the epoxy functional polydisulfide was 7,554, determined by gel permeation chromatography using Waters 2695 separation module with a Waters 410 differential refractometer (RI detector), using polystyrene standards, tetrahydrofuran (THF) as the eluent at a flow rate of 1 ml/min and two PL Gel Mixed C columns for separation.

### Example 2

Two component (2K) epoxy/thiol compositions, Adhesives 1-5, were prepared using the components in Table 2.

Part A (Epoxy-Containing Component) was prepared using a blend of different epoxy-containing molecules (Epoxy A-D) as identified in Table 2. The functionality and equivalent weight of each Epoxide A-D is provided in Table 3.

Part B (Thiol-Containing Component) was prepared using a blend of different thiol-containing molecules (Thiol A-C) as identified in Table 2. The functionality and equivalent weight of each Thiol A-C is provided in Table 3.

Thermal conductivity and other test results of Adhesives 1-5 are also shown in Table 2.

Thermal Aging Tests: Part A and Part B of Adhesives 1 and 3 were prepared using materials shown in Table 2 to make pumpable components. Part A and Part B of each adhesive composition were mixed together until blended. The adhesive compositions were pressed into sheets at a thickness of 3 mm. The sheets were then cured at ambient temperature for 7 days. Following cure, thermal conductivity, vertical burning, and tensile test samples were used for thermal ageing tests at in an oven at 60 °C for time-points spanning 0-1000 h. For each time point, the samples were allowed to cool to ambient temperature for 6-12 h, followed by measurement of thermal expansion, thermal conductivity, vertical burning, and tensile properties. The results are tabulated in table 2a.

TABLE 2
Compositions and Testing of Adhesives 1-5

| | Adhesive | Adhesive | Adhesive | Adhesive 4 (g) | Adhesive 5 |
|---|---|---|---|---|---|
| | 1 (g) | 2 (g) | 3 (g) | Comparative | (g) |
| Part A Epoxy Component | | | | | |
| Epoxy A¹ | 2 | 2 | 2 | — | 2 |
| Epoxy B² | 2 | 2 | 2 | 7 | 2 |
| Epoxy C³ | 6 | 6 | 6 | — | 6 |
| Epoxy D⁴ | 6 | 6 | 6 | — | 6 |
| Wetting and Dispersing Additives | 3 | 0.70 | 3 | — | 3 |
| Thermally Conductive Fillers⁵ | 120 | 70 | 120 | 70 | 120 |
| Expancel (043 DU 80) | — | — | 2 | 1.35 | — |
| Expancel (920 DU 120) | 2 | 2 | — | — | 2 |
| Part B Thiol Component | | | | | |
| Thiol A⁶ | 3.20 | 3.20 | 3.20 | 5.00 | — |
| Thiol B⁷ | 6 | 6 | 6 | — | — |
| Thiol C⁸ | 3.00 | 3.00 | 3.00 | — | 15 |
| Accelerator | 1.60 | 1.0 | 1.60 | 1.60 | 1.60 |
| Wetting and Dispersing Additives | 5 | 1.0 | 5 | 5 | 5 |
| Thermally Conductive Fillers⁵ | 120 | 70 | 120 | 70 | 128 |
| Expancel (043 DU 80) | — | — | 2 | — | — |
| Expancel (920 DU 120) | 2 | 2 | — | 1.35 | 2 |
| Results | | | | | |
| Expansion ratio (ΔV): | 5.85 | 3.78 | 4.74 | Not | 4.12 |
| | | | | measurable | |
| Mode of expansion | cohesive | cohesive | cohesive | Non- | cohesive |
| | | | | cohesive | |
| Thermal Conductivity (W/mK): | | | | | |
| Pre-expansion | 3.11 | 2.41 | 3.11 | 3 | 3 |
| Post-expansion | 0.09 | 0.14 | 0.09 | Not | 0.08 |
| | | | | measurable | |
| Volume Resistivity (Ω · m) | | | | | |
| Pre-expansion | 2.70E+08 | Not | Not | Not | Not |
| | | measured | measured | measured | measured |
| Post-expansion | 2.10E+08 | Not | Not | Not | Not |
| | | measured | measured | measured | measured |
| Vertical burning test rating: | V0 | V0 | V0 | Failure | Failure |
| Tensile Properties: | | | | | |
| Tensile Stress (MPa) | 0.7 ± 0.1 | 1.1 ± 0.1 | 0.66 ± 0.03 | Not | Not |
| | | | | measured | measured |
| Tensile Strain (%) | 6 ± 1 | 12 ± 1.4 | 6.5 ± 0.3 | Not | Not |
| | | | | measured | measured |

¹A difunctional bisphenol A/epichlorohydrin (Epon 828 available from Hexion Chemicals Co.)
²Diglycidyl ether of 1,4-butanediol (Heloxy 67 available from Hexion Chemicals Co.)
³Epoxy functional disulfide of Example 1
⁴Polypropylene glycol terminated epoxide (DER 732 available from Sigma-Aldrich)
⁵A blend of aluminum oxide and aluminum hydroxide
⁶2,2′-(Ethylenedioxy) diethanethiol (available from Sigma-Aldrich)
⁷Thiol-terminated polythioether (Permapol 3.1E (2.3) available from PRC-DeSoto International, Inc.)
⁸Thiol-terminated polyether liquid polymer (POLYTHIOL QE-340M available from Toray Industries, Inc.)

TABLE 2a

| | | Thermal Conductivity | | | | | | | | Thermal | |
|---|---|---|---|---|---|---|---|---|---|---|---|
| | | pre- | | post- | | Tensile Properties | | | | Expansion | |
| | time | expansion | | expansion | | Stress | | Strain | | Ratio | |
| | (h) | (W/mk) | st. dev | (W/mk) | st. dev | (MPa) | st. dev | (%) | st. dev | (ΔV) | st. dev |
| Adhesive | 0 | 3.17 | 0.009 | 0.077 | 0.020 | 0.8 | 0.11 | 9.91 | 0.88 | 5.96 | 0.07 |
| 1 | 100 | 3.20 | 0.021 | 0.064 | 0.000 | 1.11 | 0.15 | 7.24 | 0.2 | 6.28 | 0.24 |
| | 250 | 3.29 | 0.050 | 0.065 | 0.002 | 0.73 | 0.26 | 5.09 | 1.69 | 7.26 | 0.39 |
| | 500 | 3.25 | 0.008 | 0.060 | 0.0002 | 1.06 | 0.1 | 5.41 | 2.7 | 7.54 | 0.47 |
| | 1000 | 3.21 | 0.011 | 0.057 | 0.002 | 1.08 | 0.09 | 3.87 | 0.72 | 6.70 | 0.47 |
| Adhesive | 0 | 3.33 | 0.012 | 0.087 | 0.001 | 0.65 | 0.14 | 8.92 | 1.56 | 5.64 | 0.21 |
| 3 | 100 | 3.31 | 0.013 | 0.092 | 0.005 | 1.14 | 0.02 | 7.05 | 0.39 | 5.07 | 0.04 |
| | 250 | 3.29 | 0.016 | 0.184 | 0.018 | 1.03 | 0.13 | 5.31 | 1.08 | 5.30 | 0.16 |
| | 500 | 3.35 | 0.025 | 0.118 | 0.010 | 1.41 | 0.35 | 7.68 | 1.74 | 3.84 | 0.12 |
| | 1000 | 3.32 | 0.001 | 0.140 | 0.015 | 0.98 | 0.16 | 3.36 | 0.77 | 3.74 | 0.002 |

TABLE 3

| | | Equivalent |
|---|---|---|
| | | Weight |
| | Functionality | (g/eq) |
| Epoxy A | 2 | 188.5 |
| Epoxy B | 2 | 130.5 |
| Epoxy C | 3 | 825 |
| Epoxy D | 2 | 320 |
| Thiol A | 2 | 91.2 |
| Thiol B | 2.3 | 1500 |
| Thiol C | 3 | 275 |

Part A and Part B of Adhesives 1-5 were prepared using materials shown in Table 2 to make pumpable components. Part A and Part B of each adhesive composition were mixed together until blended. The adhesive compositions were pressed into sheets at a thickness of 3 mm. The sheets were then cured at ambient temperature for 7 days. Following cure, thermal conductivity, vertical burning, and tensile properties were measured.

Samples for testing tensile strength and tensile strain were prepared by cutting the cured sheets into dogbones. The tensile properties were measured by ISO-37 TYPE 2 at a pull rate of 10 mm per minute using an Instron model 3345. Samples for testing thermal conductivity and thermal expansion were prepared by cutting out circular pieces with a diameter of approximately 33 mm. The dimensions of each sample were measured pre- and post-expansion using a caliper then used to calculate the volume expansion ratio. Thermal expansions were performed for 30 minutes in an oven preheated to 120 °C and 160 °C for samples containing Expancel 043 du 80 and Expancel 920 du 120, respectively. Each sample was thermally expanded with a weight to exert a pressure of 3.2 kPa. Thermal conductivity of each sample was measured pre-expansion measured using a Modified Transient Plane Source (MTPS) method conformed to ASTM D7984 with a TCi Thermal Conductivity Analyzer using a sample size of at least 20 mm by 20 mm with a thickness of 3 mm. Thermal conductivity of each sample was measured post-expansion measured using a Modified Transient Plane Source (MTPS) method conformed to ASTM D7984 with a TCi Thermal Conductivity Analyzer using a sample size of at least 20 mm by 20 mm with a thickness of at least 3 mm. For pre-expansion samples, the ceramic materials method was used with deionized water as the contact agent. For post-expansion samples, the polymer material method was used with Wakefield Type 120 Silicone thermal grease as the contact agent. If the sample fell below the calibration method range, the foam materials method was used with no contact agent.

Flame retardance performance was evaluated internally using the UL-94 vertical flame test procedure (the Standard for Safety of Flammability of Plastic Materials for Parts in Devices and Appliances testing). A sample of dimensions 5×0.5 inches was clamped vertically in a burn chamber. Surgical cotton was placed underneath each clamped sample to catch any particulates that drip off and determined whether the cotton was ignited. First, the sample is exposed to a flame for 10 seconds. Immediately after the flame is removed, duration of any form of residual burning combustion (i.e., flaming or glowing) for each sample was observed and recorded. After the residual combustion ceased, the samples were each exposed to the flame for another 10 seconds and the same observations were made and recorded. Based on these observations, each sample was rated using the rating system in Table 4. “Failure” indicates that the sample performed worse than the V2 rating.

TABLE 4

| Rating | Description |
|---|---|
| V0 | No burning combustion (flaming or glowing) for more than 10 seconds after |
| | flame is removed from first and second flame exposure. |
| | No glowing combustion for more than 30 seconds after flame is removed |
| | from second flame exposurc. |
| | No dripping of any flame particles that result in igniting the surgical cotton. |
| V1 | No burning combustion for more than 30 seconds after the flame is |
| | removed from first and second flame exposure. |
| | No glowing combustion for more than 60 seconds after second flame |
| | exposure. |
| | Sample drips flaming particles, but the particles self-extinguish before |
| | igniting the surgical cotton. |
| V2 | No burning combustion for more than 30 seconds after flame is removed for |
| | first and second exposure. |
| | No glowing combustion for more than 60 seconds after flame is removed |
| | from second exposure. |
| | Sample drips flaming particles that ignite the surgical cotton. |

Adhesives 1 and 3 illustrate the performance properties of adhesives prepared in accordance with the present disclosure. Adhesives 1 and 3 demonstrated exceptionally high thermal conductivity ≥3 W/m·K pre-expansion. After heating, the compositions expanded up to 550% in a surprisingly cohesive manner (i.e., without crumbling) and exhibited remarkably low thermal conductivity≤0.05 W/m·K.

For comparative examples Adhesives 4 and 5, crosslinking was adjusted by the omission or change in the level of Thiol B, a polythiol containing a thiol functionality greater than 3. Adhesive 4 had no or insufficient crosslinking and crumbled upon expansion. Adhesive 5 had too much crosslinking and did not expand.

### Example 3

Two component (2K) epoxy/thiol compositions, Adhesives 6 to 8, were prepared using the components in Table 5.

Part A (Epoxy Component) was prepared using a blend of different epoxies (Epoxy A-D). The functionality and equivalent weight of Epoxy A-D are provided in Table 3.

Part B (Thiol Component) was prepared using a blend of different thiol functional group-containing molecules (Thiol A-C). The functionality and equivalent weight of Thiol A-C are provided in Table 3.

Test results of Adhesives 6 to 8 are also shown in Table 5.

TABLE 5

| | Adhesive | Adhesive | Adhesive 8 (g) |
|---|---|---|---|
| | 6 (g) | 7 (g) | comparative |
| Part A Epoxy Component* | | | |
| Epoxy A | 6.00 | 6.00 | 2.00 |
| Epoxy B | 4.00 | 1.50 | — |
| Epoxy C | — | — | 9.00 |
| Epoxy D | 2.00 | 2.00 | — |
| Wetting and Dispersing | 1.80 | 1.80 | 5.00 |
| Additives | | | |
| Thermally Conductive Fillers | 88.00 | 80.00 | 130.00 |
| Expancel (043 DU 80) | — | — | 2.1 |
| Expancel (920 DU 120) | 1.60 | 1.60 | — |
| Part B Thiol Component** | | | |
| Thiol A | 4.00 | 4.00 | — |
| Thiol B | — | — | 15.00 |
| Thiol C | 7.00 | 7.00 | 3.00 |
| Accelerator | 0.50 | 0.50 | 1.60 |
| Wetting and Dispersing | 1.80 | 1.80 | 5.00 |
| Additives | | | |
| Fillers | | | |
| Thermally Conductive Fillers | 88.00 | 80.00 | 154.00 |
| Expancel (920 DU 120) | 1.60 | 1.60 | — |
| Thiol/epoxide ratio | 1.00 | 1.40 | 1.00 |
| Results | | | |
| Expansion ratio (ΔV): | 1.08 | 2.27 | Not |
| | | | measurable |
| Mode of expansion | cohesive | cohesive | Non-cohesive |
| Thermal Conductivity | | | |
| (W/m · K): | | | |
| Pre-expansion | 2.84 | 2.89 | Not |
| | | | measurable |
| Post-expansion | 2.54 | 0.52 | Not |
| Vertical burning test rating: | | | measurable |
| Tensile Properties: | | | |
| Tensile Stress (MPa) | 1.26 ± 0.06 | Not | Not |
| | | measured | measurable |
| Tensile Strain (%) | 3.02 ± 0.26 | Not | Not |
| | | measured | measurable |

*The epoxies and the thermally conductive fillers used in Part A are the same as those shown in Table 2.
**The thiols and the thermally conductive fillers used in Part B are the same as those shown in Table 2.

Adhesive compositions shown in Table 5 were prepared and tested using the same methods as described in Example 1.

For Adhesives 6-8, crosslink density was manipulated by changing the ratio of thiol to epoxide or by using components with different epoxy or thiol equivalent weights to change the molar mass between crosslinks.

For Adhesives 6 and 7, the degree of crosslinking was decreased by using an excess amount of thiol to increase the thiol/epoxide ratio. As shown, when the thiol/epoxide ratio increased, the expansion ratio also increased.

Adhesives 6 and 8 have the same thiol/epoxide ratio, but Adhesive 8 has a higher molar mass between crosslinks (hence lower degree of crosslinking) due to the incorporation of an epoxy comprising a higher epoxy equivalent weight and a thiol comprising a higher thiol equivalent weight in the adhesive composition. Consequently, Adhesive 8 had a higher degree of expansion than Adhesive 6.

TABLE 6
Compositions and Testing of Adhesives 9 and 10

| | Adhesive 9 (g) | Adhesive 10 (g) |
|---|---|---|
| Part A Epoxy Component* | | |
| Epoxy A | 5 | 5 |
| Epoxy B | 5 | 5 |
| Epoxy C | 15 | 15 |
| Epoxy D | 15 | 15 |
| Epoxy E⁹ | | |
| Wetting and Dispersing | 2.5 | 2.5 |
| Additives | | |
| Thermally Conductive | 130 | 155 |
| Fillers** | | |
| Expancel (043 DU 80) | 2.6 | 12.25 |
| Part B Thiol Component*** | | |
| Thiol A | 3.20 | 3.20 |
| Thiol B | 6.0 | 6.0 |
| Thiol C | 3.0 | 3.0 |
| Thiol D¹⁰ | | |
| Accelerator | 4 | 4 |
| Wetting and Dispersing | 2.5 | 2.5 |
| Additives | | |
| Thermally Conductive | 130 | 155 |
| Fillers** | | |
| Expancel (043 DU 80) | 2.5 | 12.25 |
| Results | | |
| Thermal Expansion Oven | | |
| Expansion ratio (ΔV) | Not measured | Not measured |
| Mode of expansion | Cohesive | Cohesive |
| Thermal Conductivity | | |
| (W/m · K): | | |
| Pre-expansion | 1.7 | 1.6 |
| Post-expansion | See Table 7 | See Table 7 |
| Tensile Properties: | | |
| Tensile Stress (MPa) | Not measured | Not measured |
| Tensile Strain (%) | Not measured | Not measured |

*Epoxies A through D were the same as in Table 2.
**Thermally conductive fillers were the same as in Table 2.
***Thiols A through C were the same as in Table 2.
⁹Hypox DA 323-Adduct of a DGEBA resin and a dimer fatty acid from Huntsman Corporation.
¹⁰Capcure 3800-Polymercaptan epoxy hardener available from Gabriel Performance Products, LLC.

Part A and Part B of Adhesives 9 and 10 were prepared using materials shown in Table 6 to make pumpable components. Part A and Part B of each adhesive composition were mixed together until blended. The adhesive compositions were transferred into 2 oz glass jars followed by inserting two (0.063×1.0×2.8 inch) pouch cell mockups. Ultimately, jars A and B contained adhesive 9 and jars C and D contained adhesive 10. The remainder of the adhesive compositions were pressed into sheets at a thickness of 3 mm. The jars and sheets were subsequently cured at ambient temperature for 7 days. Following cure, pre-expansion thermal conductivity was measured and thermal expansion under confinement was performed.

Thermal expansions under confinement were performed in an oven preheated to 120 °C. Jar A was placed in the oven with no weight atop, jar B and C had 1 kg weights atop, and jar D had a screwed cap. Jar D expanded uncohesively. The samples were allowed to expand for 30 minutes.

TABLE 7

| Sample | Adhesive | | Post-Expansion Thermal |
|---|---|---|---|
| ID | type | Variation | Conductivity (W/m · K) |
| Jar A | Adhesive 9 | no cap and no | 0.18 |
| | | weight atop | |
| Jar B | Adhesive 9 | 1 kg weight | 1.45 |
| | | atop | |
| Jar C | Adhesive 10 | 1 kg weight | 0.04 |
| | | atop | |
| Jar D | Adhesive 10 | screwed cap | Unmeasurable due to |
| | | | non-cohesive material |

TABLE 8

| | Adhesive 11 (g) | Adhesive 12 |
|---|---|---|
| | comparative | (g) |
| Part A Epoxy Component \hat{ } | | |
| Epoxy A | 3 | 3 |
| Epoxy B | 3.77 | 3.77 |
| Epoxy C | | |
| Epoxy D | | |
| Epoxy E | 13.5 | 13.5 |
| Wetting and Dispersing | 3.5 | 3.5 |
| Additives | | |
| Thermally Conductive Fillers | 124 | 136 |
| Expancel (920 DU 120) | — | 2.20 |
| Part B Thiol Component \hat{ }\hat{ } | | |
| Thiol A | 5 | 5 |
| Thiol B | 2 | 2 |
| Thiol C | | |
| Thiol D | 2.5 | 2.5 |
| Accelerator | 1 | 1 |
| Wetting and Dispersing | 3.5 | 3.5 |
| Additives | | |
| Thermally Conductive Fillers | 90 | 100 |
| Expancel (920 DU 120) | — | 2 |
| Results | | |
| Sandwiched Indirect Propane | | |
| Torch Tests | | |
| Expansion ratio (ΔV): | 1.6 | 2.4 |
| Backside Temperature at 500 s | 320 °C | 233 °C |
| Thermal Conductivity | | |
| (W/m · K): | | |
| Pre-expansion | 3.0 | 3.0 |
| Post-expansion | Not measured | Not measured |
| Vertical burning test rating: | V0 | V0 |

\hat{ }The epoxies and the thermally conductive fillers used in Part A are the same as those shown in Table 6.
\hat{ }\hat{ }The thiols and the thermally conductive fillers used in Part B are the same as those shown in Table 6.

Part A and Part B of Adhesives 11 and 12 were prepared using materials shown in Table 8. Part A and Part B of each adhesive composition were mixed together until blended. Sandwiched samples for indirect propane torch testing, were prepared by uniformly pressing the mixed part A and B between two (4×12×0.032 inch, C700 C59) steel panels (targeting 3 mm thick layer of material between the panels) using a Carver laboratory press (commercially available from Fred S. Carver INC.). The remainder of the mixed part A and B was pressed into 3 mm sheets, which were used for thermal conductivity measurements. The sandwiched panels and sheets were subsequently cured at ambient temperature for 7 days. Following cure, pre-expansion thermal conductivity was measured and thermal expansion under confinement was performed.

Samples for testing thermal conductivity were prepared by cutting out circular pieces (diameter ~33 mm). The dimensions of each sample were measured using a caliper, and these metrics were used to determine the volume expansion ratio (AV) post propane torch tests.

The propane torch experiments were performed using a (add details) at a 2-bar hose pressure. The incident flame temperature was measured to be 1100 °C, and the backside temperature was monitored over 500s using a 1/16 O.D. K-type MgO-filled Inconel 600 ungrounded thermocouple connected to a DATAQ Instruments Graphtec GL240 data logger with sample rate of 1/s.

The examples illustrate that compositions prepared in accordance with the present disclosure have a surprisingly high degree of thermal expansion. The compositions also have good vertical burn ratings.

### Example 4

TABLE 9

| Component | I (epoxy masterbatch) | II (amine masterbatch) |
|---|---|---|
| Kane Ace MX-136¹ | 60.00 | |
| Epon 863² | 58.00 | |
| Ancamine 2638³ | | 60.00 |
| Ancamine K-54⁴ | | 2.00 |
| Expancel 920 DU 120⁵ | 13.56 | 6.32 |
| Total | 131.56 | 68.32 |
| New Epoxy EW | 212.73 | |
| New Amine EW | | 110.45 |

¹Diglycidylether of bisphenol F with core-shell rubber available from Kaneka
²Diglycidylether of bisphenol F available from Hexion Specialty Chemicals
³Amine curative available from Hexion Specialty Chemicals
⁴tris-(dimethylaminomethyl)phenol available from Evonik
⁵Thermoplastic microsphere blowing agent available from Nouryon

Components I and II (epoxy and amine masterbatches, respectively), were used to prepare comparative compositions 13 and 14. All were prepared in a 60 max DAC cup as separate parts A and B. Wet components were all added and mixed for 2 minutes at 2350 RPM using a Dual-Asymmetric Mixer (SpeedMixer®). Dry components were added and mixed for an additional 2 minutes in the same manner. P arts A and B were then blended and mixed again in the same manner. These samples were then cured at 50 °C for 24 hours. After curing, the samples were allowed for 1 hour to cool to room temperature. A portion of the samples were then “activated” by heating to 160 °C for 1 hour before being tested.

| Component | Adhesive 13 (Comparative) | Adhesive 14 (Comparative) |
|---|---|---|
| Component I (epoxy masterbatch) | 25.70 | 10.66 |
| Wetting and Dispersant Additives | 0.52 | 0.52 |
| Thermally conductive fillers | | 26.00 |
| Component II (amine masterbatch) | 13.30 | 5.50 |
| Wetting and Dispersant Additives | | 0.32 |
| Thermally conductive fillers | | 16.00 |
| 10 mil glass spacer beads⁶ | 1.00 | 1.00 |
| Total | 40 | 60 |
| Pre-expansion Volume (mm²) | 3053.4 | 2776.1 |
| Post-expansion Volume | 3313.5 | 2799.2 |
| Expansion Ratio | 1.085 | 1.008 |
| Pre-expansion TC (W/mK) | 0.2023 | 1.2417 |
| Post-expansion TC (W/mK) | 0.2317 | 1.2017 |

⁶Glass beads available from Potters Industries Inc.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A composition, comprising:
a first component comprising a first molecule comprising an epoxy functional group;
a second component comprising a second molecule comprising a thiol functional group;
a thermally expandable material; and
a thermally conductive filler;
wherein the epoxy functional group and the thiol functional group are reactive under ambient conditions.

2. The composition of claim 1, wherein the composition is substantially free, or essentially free, or completely free, of a latent accelerator.

3. The composition of claim 1, wherein:
(a) the first component and/or the second component comprises a viscosity of 100 Pa·s to 10⁶ Pa·s at a shear stress of 1 Hz measured by an Anton Paar MCR 301 rotational rheometer at 25 °C using a parallel plate with a diameter of 25 mm (1 mm gap);
(b) the epoxy-containing molecule comprises a viscosity of 1 mPa·s to 4,000 mPa·s at 298° K and 1 atm according to ASTM D789; and/or
(c) the thiol-containing molecule comprises a viscosity of 1 mPa·s to 4,000 mPa·s at 298° K and 1 atm according to ASTM D789.

4. The composition of claim 1, wherein:
(a) the second molecule is present in an amount such that an equivalence ratio of thiol functional groups to the epoxy functional groups is 1:4 to 4:1;
(b) the composition comprises the thermally expandable material in an amount of at least 0.5 percent by weight based on total weight of the composition; and/or
(c) the composition comprises the thermally conductive filler in an amount of at least 50 percent by weight based on total weight of the composition.

5. The composition of claim 1, wherein:
(a) the thermally expandable material comprises an expansion onset temperature of at least 60 °C; and/or
(b) following exposure to at least the expansion onset temperature, the thermally expandable material comprises an expansion volume ratio of at least 1.5.

6. A method of coating a substrate comprising:
contacting a portion of a surface of the substrate with the composition of claim 1.

7. A method of forming an article comprising extruding the composition of claim 1.

8. A substrate comprising a coating formed from the composition of any of claim 1 on a portion of a surface of the substrate.

9. The substrate of claim 8, wherein the coating comprises a cohesive coating.

10. The substrate of claim 8, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

11. The substrate of claim 8, wherein the coating comprises a non-cohesive coating.

12. The substrate of claim 11, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

13. The substrate of claim 8, further comprising a dielectric coating.

14. An article comprising the substrate of claim 8.

15. The article of claim 14, wherein the article comprises a vehicle, an appliance, a personal electronic device, a circuit board, a battery cell, a multi-metal substrate, or combinations thereof.

16. The article of claim 15, wherein the vehicle comprises a land vehicle or an aircraft.

17. A battery comprising a battery cell and a coating formed from the composition of claim 1.

18. The battery of claim 17, wherein:
(a) the battery cell and the coating are housed in a module;
(b) the battery and the coating are housed in a pack;
(c) the module is housed in a pack; and/or
(d) the battery is adjacent to a vehicle chassis.

19. The battery of claim 17, wherein the coating comprises a cohesive coating.

20. The battery of claim 17, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa;
(e) a pre-expansion tensile strain of at least 5% measured according to ISO-37 TYPE 2 at a pull rate of 10 mm per minute, such as at least 6%; and/or
(f) a vertical burning test rating of VO.

21. The battery of claim 17, wherein the coating comprises a non-cohesive coating.

22. The battery of claim 17, wherein the coating comprises:
(a) a pre-expansion thermal conductivity of at least 0.5 W/m·K at 25 °C and measured using a Modified Transient Plane Source (MTPS) method conformed to ASTM D7984 with a TCi Thermal Conductivity Analyzer using a sample size of at least 20 mm by 20 mm with a thickness of 3 mm, such as at least 1 W/m·K, such as at least 2 W/m·K, such as at least 3 W/m·K, such as at least 4 W/m·K, such as at least 5 W/m·K;
(b) post-expansion, a decrease in thermal conductivity of at least 10%, such as at least 25%, such as at least 50%, such as at least 75%, such as at least 95%, such as at least 96%, such as at least 97%, such as at least 98%, such as at least 99%, compared to a pre-expansion thermal conductivity;
(c) an expansion volume ratio of greater than 1, such as at least 1.1, such as at least 1.2, such as at least 1.5, such as at least 2, such as at least 3, such as at least 5, such as at least 10, such as at least 20;
(d) a pre-expansion tensile stress of at least 0.5 MPa measured according to ISO-37 TYPE 2 at a pull rate of 10 mm per minute, such as at least 0.6 MPa, such as at least 0.7 MPa; and/or
(e) a pre-expansion tensile strain of at least 5% measured according to ISO-37 TYPE 2 at a pull rate of 10 mm per minute, such as at least 6%.

23. The battery of claim 17, further comprising a dielectric coating.
